(19) United States
(12) Patent Application Publication
(10) Pub. No.: US 2024/0140807 A1
(43) Pub. Date: May 2, 2024

(54) SWEEPING GAS PROCESS FOR PRODUCTION OF ACTIVATED CARBON-BASED ELECTRODE MATERIALS

(71) Applicant: CARBONIP TECHNOLOGIES INC., Port Coquitlam, (CA)

(72) Inventors: Jin Kwon TAK, Vegreville (CA); Earl JENSON, Vegreville (CA); Matthew SIEBERT, Vancouver (CA)

(21) Appl. No.: 18/276,694

(22) PCT Filed: Feb. 15, 2022
(86) PCT No.: PCT/CA2022/050218

§ 371 Date: Aug. 10, 2023

Related U.S. Application Data
(60) Provisional application No. 63/150,244, filed on Feb. 17, 2021.

(51) Int. Cl. C01B 32/324; C01B 32/336; H01G 11/34; H01M 4/583

(52) U.S. Cl. CPC C01B 32/324; C01B 32/336; H01G 11/34; H01M 4/583; C01P 2006/12; C01P 2006/14

(57) ABSTRACT

Activated carbons and methods of making activated carbons are provided. The activated carbon can be produced by activating lignin or a high-lignin feedstock and then subjecting the activated carbon to a sweeping gas at a first elevated temperature.

### CROSS-REFERENCE TO RELATED APPLICATIONS

This application claims priority to, and the benefit of, U.S. provisional patent application No. 63/150,244 filed 17 Feb. 2021 entitled Sweeping Gas Process for Production of Activated Carbon-Based Electrode Materials, the entirety of which is incorporated by reference herein in its entirety for all purposes.

### TECHNICAL FIELD

Some embodiments relate to methods for making activated carbon having a relatively high conductance. Some embodiments relate to methods for making activated carbon having a relatively low oxygen content. Some embodiments relate to activated carbon made by the methods described herein. Some embodiments relate to supercapacitors or batteries having electrodes made from such materials. Some embodiments relate to buildings and modular building components containing energy storage structures having electrodes made from such materials.

### BACKGROUND

Electrochemical energy storage devices use physical and chemical properties to store energy. For example, supercapacitors use a physical storage mechanism to generate high power with a long lifetime. Batteries employ redox reactions to create energy.

The electrodes of energy storage systems require high adsorptive capacity with good microporocities and low electrical resistances in supercapacitor and battery applications, including lithium-sulphur (LiS) battery applications. Typical activated carbons have high adsorptive capabilities, but generally not suitable electrical properties. The typical activated carbon has oxygen-related functional groups which are chemically bound on the surface, which can contribute to a shortening of the lifespan of the supercapacitors and lithium-sulphur batteries.

Subject to addressing the shortcomings of their electrical properties, carbon materials such as activated carbon can provide a useful material for the manufacture of electrodes. For example, carbon-based materials can be designed as highly porous materials so as to have a high surface area. The pore sizes in the material can be microporous primarily to provide a high surface area. Carbon materials can also offer good adsorption (i.e. adhesion of ions onto the surface of the material) and low resistance (i.e. efficient electron and ion movement at high current). Carbon pore sizes can be described as micropores (having a pore width of less than 2 nm), mesopores (having a pore width of between 2 nm and 50 nm) and macropores (having a pore width of greater than 50 nm).

Activated carbon has been used for electrode materials due to high surface area (1,000-3,000 m²/g). Activated carbons are widely produced from many natural substances such as coal (lignite, bituminous, and anthracite coal), peat, wood, and coconut shell. Among these natural raw materials, coconut shell makes a good activated carbon because of predominant microporocity which is less than 2 nm that the supercapacitor carbon requires.

The production of activated carbons mainly involves carbonization and activation with an oxidizing agent. The carbonization converts the natural substances into char (carbon) in the absence of oxygen. The char is partially oxidized to produce activated carbon. The activation develops the porous surface of activated carbons, but this partial oxidation process can not remove oxygen-containing functional groups. Oxygen-containing functional groups can create parasitic reactions for supercapacitors that diminish the initial capacitance and limit the lifespan when activated carbons are used for electrode materials of supercapacitors. The oxygen-containing functional groups also create high electrical resistances for supercapacitors and for battery applications such as lithium-sulphur applications.

Examples of potential applications for activated carbon materials with improved electrical properties include supercapacitors and batteries, including metal sulphur, e.g. lithium-sulphur (LiS), batteries. Supercapacitors are high capacity capacitors that can bridge the gap between electrolytic capacitors and rechargeable batteries. Supercapacitors can potentially store more power per unit volume or mass than electrolytic capacitors (e.g. typically 10 to 100 times more power), and can accept and deliver charge much faster than batteries because charging/discharging involves only physical movement of ions, not a chemical reaction. Supercapacitors can also tolerate many more charge and discharge cycles than can a battery, and are useful for bursts of power, for example to recover and supply electrical power in a hybrid vehicle during regenerative braking or for energy storage as part of a building or building component. Carbon is a desirable material for supercapacitors because it has high surface area, low electrical resistance and favourable cost.

A growing area of interest in rechargeable battery technology is lithium-sulphur (Li—S) batteries. A lithium-sulphur battery has a lithium-metal anode and a sulphur cathode. Sulphur is impregnated in micropores of activated carbon as a host material which provides electrically conductive and adsorptive capability for sulphur species in the lithium-sulphur battery system. Sulphur and lithium have theoretical capacities of 1672 or 1675 mA h g⁻¹, respectively. As such, a theoretical energy density of a Li—S battery is 2500 Wh kg⁻¹, which is one of the highest theoretical energy densities among rechargeable batteries. As such, lithium-sulphur batteries provide a promising electrical energy-storage system for portable electronics and electric vehicles.

Lithium-sulphur (LiS) batteries operate by reduction of sulphur at the cathode to lithium sulphide:

S+16Li↔8Li₂S(2.4V−1.7V)

The sulphur reduction reaction to lithium sulphide is complex and involves the formation of various lithium polysulphides (Li₂Sₓ, 8<x<1, e.g. Li₂S₈, Li₂S₆, Li₂S₄, and Li₂S₂).

In the case of some lithium-sulphur batteries, the anode can be pure lithium metal (Li° oxidized to Li⁺ during discharge), and in some cases the cathode can be activated carbon containing sulphur (S° reduced to S²⁻ during discharging). An ion-permeable separator is provided between the anode and the cathode, and an electrolyte used in such systems is generally based on a mixture of organic solvents such as cyclic ethers such as 1,2-dimethoxyethane (DME) and 1,3-dioxolane (DOXL) containing 1 molar lithium bis(trifluoromethane sulfonyl)imide (LiN(SO₂CF₃)₂) and 1% lithium nitrate, or the like.

Potential advantages of lithium-sulphur batteries include a high energy density (theoretically 5 times although practically 2-3 times more than lithium-ion), there is no requirement for top-up charging when in storage (whereas a lithium-ion battery may require 40% regular recharging to prevent capacity loss), the active materials are lighter as compared to lithium-ion, and the materials used in the manufacture of lithium-sulphur batteries are more environmentally friendly and less expensive than lithium-ion batteries (since no rare earth metals are required).

However, there are challenges for lithium-sulphur battery systems that have not yet been addressed sufficiently to make them commercially useful. For example, lithium polysulphides (Li₂Sₓ where x is an integer between 3 and 8) dissolve in the electrolyte and further reduce to insoluble lithium sulphide (e.g. Li₂S₂ to Li₂S) that forms on the anode in the battery systems. Such formations create a loss of active material, resulting in a short life cycle (i.e. fewer discharging and charge cycles) that is not commercially useful.

Also, because sulphur is electronically and ionically insulating, sulphur needs to be embedded into a conductive matrix to be used in a lithium sulphur battery. Carbon is a potentially useful material for lithium-sulphur battery electrodes because it has a microporous structure that traps the deposition of lithium polysulphide, and can help to minimize electrode expansion during discharge. The cathode of a lithium-sulphur battery can be made from sulphur-impregnated activated carbon as an active material that reacts with lithium ions from the lithium metal at the anode side. The electrodes require high adsorptive capacity with microporocities and low electrical resistances for creating high capacitance for supercapacitors and trapping and mitigating the formation of insoluble polysulphides at the anode side which causes a shortened lifespan for LiS batteries.

Many forms of activated carbon also include a high percentage of oxygen, e.g. in the range of about 15%, generally in the form of oxygen-containing functional groups. Oxygen is an insulating material, and its presence in activated carbon increases the resistance of the carbon product.

The adoption of a green economy and renewable energy sources such as wind and solar power necessitate the adoption of better energy storage systems. The production of power from a renewable energy source cannot be predictably controlled, and in order for such sources to supply a significant proportion of power to a power grid, reliable and significant energy storage systems are required to balance the irregular power generation provided by the renewable energy source. The provision of meaningful energy storage systems allows power to be stored during periods of power production, and allows power to be supplied to the grid during periods of decreased power production from the renewable energy source. However, such energy storage systems must be quite large to be able to achieve the desired stabilization of the electrical grid.

One strategy to provide energy storage systems that can facilitate the widespread production of power from renewable energy sources is to incorporate such energy storage systems into buildings or building components. This strategy can allow for the storage of large amounts of energy without generating a significant separate footprint for the energy storage system. However, energy storage systems that are to be used as part of a building or building component need to be robust and reliable (e.g. have a long life encompassing many charge and discharge cycles), because replacement or repair of such systems may be difficult or disruptive to other uses of the building. Further, such energy storage systems should provide a high energy density, in order to maximize energy storage while minimizing the amount of space occupied by such energy storage systems.

There remains a need for technologies that improve the capabilities of supercapacitors and/or metal-sulphur including lithium-sulphur battery systems. The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a method of producing activated carbon by providing lignin or a high-lignin feedstock, producing activated carbon from the lignin or high-lignin feedstock, and exposing the activated carbon to a sweeping gas at a first elevated temperature. The lignin can be lignin A (lignin with a low ash content derived from woody plants, a high grade form of lignin), lignin B (lignin with a high ash content derived from woody plants, a low grade form of lignin), lignin C (lignin derived from softwood based black liquor or from wheat straw-based black liquor), or a mixture thereof. The high-lignin feedstock can be black liquor from a pulping process, for example for pulping of hardwood, softwood, or cereal grain. The cereal grain can be wheat straw.

The black liquor feedstock can be subjected to a hydrothermal carbonization process by heating under a carbonizing atmosphere such as a carbon dioxide atmosphere under pressure, e.g. at an initial pressure of 30-80 psig at a room temperature, with the temperature being increased to in the range of about 200-320° C. at a pressure of about 900-1500 psig for a period of 2-10 hours.

The sweeping gas can be a combination of an inert gas and a reducing gas. The inert gas can be nitrogen, argon or helium. The reducing gas can be hydrogen, ammonia, carbon monoxide, forming gas or syngas. The sweeping gas can contain between about 80% and about 99% of the inert gas and about 1% to about 20% of the reducing gas. The first elevated temperature can be between about 750° C. and about 950° C. The sweeping gas can be supplied at a superficial velocity of between 3.5 and 7.5 cm/minute. The sweeping gas treatment can be conducted for a period of between 0.5 hours and 9 hours.

One aspect provides an activated carbon made from lignin or a high-lignin feedstock. One aspect provides an activated carbon that is made by a process as defined herein, including an activated carbon that has been subjected to a sweeping gas process. Also provided are electrodes incorporating such an activated carbon, and supercapacitors or batteries containing such electrodes, as well as buildings or modular building components incorporating such activated carbons, supercapacitors or batteries.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 shows an example method of producing activated carbon materials using a sweeping gas process.

FIG. 2 shows an example method of producing activated carbon materials using a sweeping gas process.

FIG. 3 shows an example method of producing activated carbon materials using a sweeping gas process.

FIG. 4 shows an example method of producing activated carbon materials using a sweeping gas process.

FIG. 5 shows an example method of producing activated carbon materials using a sweeping gas process.

FIG. 6 shows an exemplary apparatus for measuring the conductivity of activated carbon used in one example.

FIG. 7 shows the experimental protocol used to fabricate supercapacitor electrodes for testing in one example.

FIG. 8 shows an example method of producing activated carbon materials using a sweeping gas process.

FIG. 9 shows the surface area and iodine values determined for activated carbon made from black liquor derived from a wheat straw pulping process.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

In one example embodiment, the inventors have developed a novel process for producing carbon having desirable physical properties. Such carbon has potential utility, for example, to manufacture electrodes for use in energy storage, for example in supercapacitors, metal-sulphur batteries, lithium-sulphur batteries, and so on. The inventors have determined that activated carbons produced from lignin or high-lignin materials (referred to herein as lignin-based activated carbons) that are subjected to a sweeping gas treatment under a reducing atmosphere exhibit significant improvements in the properties of lignin-based activated carbon as compared with a control biologically based or renewable activated carbon produced from coconut.

In particular tested example embodiments, lignin A (LA), lignin B (LB), and lignin C (LC) from black liquor (BL, which contains dissolved lignin in alkaline solution), were used to produce lignin-based activated carbons, using potassium hydroxide (KOH) as an exemplary oxidizing agent. Lignin-based activated carbons were treated with a sweeping gas (SG) treatment using a reducing gas for the removal of oxygen-containing functional groups. YP50F (YPAC, derived from coconut shell) was selected as a comparative type of biologically based renewable source activated carbon. Lignin-based activated carbons were compared to YP50F for electrochemical properties to show that the sweeping gas process described herein yields significantly better enhancements in the properties of lignin-based activated carbon as compared with activated carbon produced from a more typical renewable source of activated carbon. The inventors have also found that a high quality activated carbon can be produced through the hydrothermal carbonization of black liquor as a starting material, particularly where the black liquor is derived from wheat straw or wood pulp.

The lignin-based activated carbons tested in the examples were observed to show significantly improved adsorptive capability and electrical properties after the sweeping gas treatment resulting in high capacitance values in the tested supercapacitor applications. The sweeping gas treated lignin-based activated carbons are suitable for electrode materials in supercapacitors and battery applications such as metal-sulphur including lithium-sulphur batteries. The sweeping gas treatment described herein was observed to be particularly effective in enhancing the properties of lignin-based activated carbon as compared with coconut shell-based activated carbon.

As used herein a renewable source of activated carbon refers to a source of carbon that can replenish itself naturally (e.g. that is derived from a biologically based source such as lignin or coconut), as opposed to a non-renewable source of activated carbon such as coal or oil by-products.

As used herein, lignin refers to lignin A, lignin B and lignin C. A high-lignin feedstock refers to a material that contains a significant proportion of lignin (e.g. between 65% and 98% or higher lignin dry matter content, including any subrange therebetween e.g. at least 65%, 70%, 75%, 80%, 85%, 90%, 95%, 96%, 97%, 98% or greater than 98% lignin dry matter content by weight), or from black liquor obtained from a pulping process (which typically contains between 10-15% lignin in its wet matter content, including any value therebetween including 11, 12, 13 or 14% lignin by weight, and which may contain at least 20-35% or higher recoverable lignin by weight in its dry matter content including any subrange therebetween e.g. at least 20%, 21%, 22%, 23%, 24%, 25%, 26%, 27%, 28%, 29%, 30%, 31%, 32%, 33%, 34% or 35% recoverable lignin by weight on a dry matter basis). In some embodiments, the high-lignin feedstock has a recoverable lignin content of between 65% and 98% or higher by weight on a dry basis, including any subrange therebetween e.g. at least 65%, 70%, 75%, 80%, 85%, 90%, 95%, 96%, 97%, 98% or greater than 98% recoverable lignin by weight on a dry basis).

In some embodiments, the black liquor is obtained from a pulping process involving hardwoods. In some embodiments, the black liquor is obtained from a pulping process involving softwoods. In some embodiments, the black liquor is obtained from a pulping process involving both hardwoods and softwoods. In some embodiments, the black liquor is obtained from a kraft pulping process (for example black liquor obtained using the LignoForce™ process). In some embodiments, the kraft pulping process is a soda pulping process (i.e. a sulphur-free process). In some embodiments, the black liquor is obtained from a pulping process involving another feedstock such as a cereal grain, for example wheat straw.

In one example embodiment, activated carbon is produced from lignin or a high-lignin feedstock, including e.g. from black liquor which contains lignin, and subjected to a sweeping gas treatment to remove oxygen from the material, to produce an activated carbon having desirable properties. Without being bound by theory, it is believed that reducing the amount of oxygen present in the activated carbon decreases the resistance of the activated carbon (i.e. increases its conductivity). This may provide high capacitance and/or capacitance retention at a fast discharge rate or a high discharge current density (A/g) of activated carbon in the cell of the supercapacitor). The sweeping gas treatment has been found by the inventors to be particularly beneficial in improving the quality of activated carbon produced from lignin or high-lignin feedstocks. The inventors have also developed a hydrothermal carbonization process that can be used to produce activated carbon from black liquor starting materials.

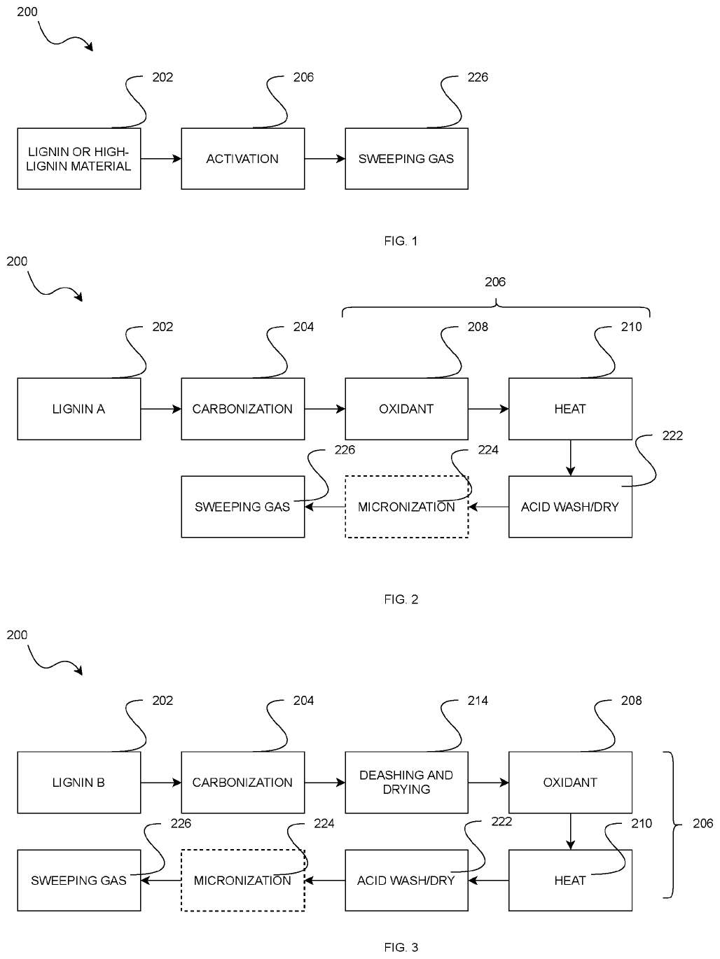

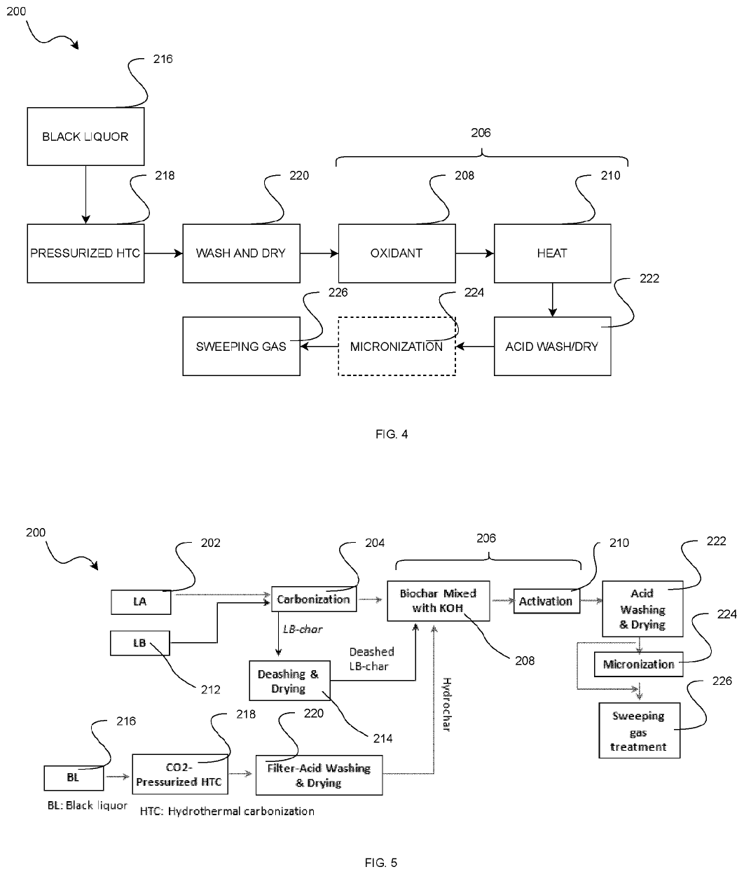

With reference to FIGS. 1-5, example embodiments of a process 200 for preparing activated carbon using lignin or a high-lignin feedstock are illustrated. In some embodiments the lignin or high-lignin feedstock is lignin A, lignin B, a mixture of lignin A and lignin B, lignin C, or black liquor (e.g. as obtained from the Kraft pulping process). In some embodiments, the process shown in FIG. 1 can be used. In some embodiments, additional steps as illustrated in FIGS. 2, 3, 4 and 5 can be used. In some embodiments, the steps used to produce the activated carbon can be varied depending on the lignin or high-lignin feedstock used. For example, in some embodiments where the lignin is lignin A, the method steps illustrated in FIG. 2 are used. In some embodiments where the lignin is lignin B, the method steps illustrated in FIG. 3 are used. In some embodiments where the high-lignin feedstock is black liquor, the method steps illustrated in FIG. 4 are used. FIG. 5 shows an example of potential interrelations between the various steps of method 200 for different feedstocks as starting materials.

Generally as shown in FIG. 1, at 202 the lignin or high-lignin feedstock is supplied. At 206 the feedstock is activated to produce an activated carbon, and at 226 the activated carbon is subjected to a sweeping gas process as described herein.

With reference to FIG. 2, in some embodiments, at 202, the lignin or high-lignin feedstock is supplied. In some such embodiments, the lignin or high-lignin feedstock that is supplied at 202 is lignin A. The lignin or high-lignin feedstock is subjected to a carbonization process at 204, for example by heating in an atmosphere that is free of oxygen, e.g. an inert atmosphere that is suitable for carbonization (e.g. argon, nitrogen, carbon dioxide or the like) at a temperature in the range of about 500-900° C. for about 1-5 hours, including any values therebetween e.g. 550, 600, 650, 700, 750, 800 or 850° C. for 1.5, 2, 2.5, 3, 3.5, 4 or 4.5 hours. At 206, the resultant lignin-based char (carbonized lignin A or lignin A based char) is activated in any suitable manner, for example by using physical or chemical activation such as carbonization, pyrolysis (optionally under an inert atmosphere), steam activation, addition of a strong acid, strong base or salt and subsequent heating at a temperature in the range of about 250-900° C. for about 1-5 hours, including any values therebetween e.g. 300, 350, 400, 450, 500, 550, 600, 650, 700, 750, 800 or 850° C. for 1.5, 2, 2.5, 3, 3.5, 4 or 4.5 hours, or the like. In the illustrated embodiment, the activation of the carbonized lignin A is conducted using the addition of potassium hydroxide as an oxidant at 208 followed by heating at 210. However, in alternative embodiments, other modes of activation could be used.

In the illustrated embodiment, activation step 206 is carried out by first combining the carbonized lignin A with an oxidant such as an alkali metal hydroxide (e.g. potassium hydroxide (KOH)) to carry out the activation step. E.g. in exemplary embodiments, KOH can be provided at a suitable concentration, e.g. at a concentration in the mass ratio range of 1 part lignin char:4 parts KOH, or 1:1, 1:2 or 1:3, at step 208. The mixture is then activated at step 210 by heating at a temperature in the range of about 500-900° C. for a period of about 0.5-5 hours (including any values therebetween e.g. 550, 600, 650, 700, 750, 800 or 850° C. for 1, 1.5, 2, 2.5, 3, 3.5, 4 or 4.5 hours, or the like) under an inert gas velocity of 3.5 to 7.5 cm/minute (including any value therebetween e.g. 4.0, 4.5, 5.0, 5.5, 6.0, 6.5 or 7.0 cm/minutes) to carry out the activation step. In alternative embodiments, activation step 206 could be carried out using any method currently known or developed in future for producing activated carbon from lignin or a high-lignin feedstock.

As illustrated with reference to FIG. 3, in some embodiments, the source of lignin is lignin B which is optionally supplied at 212 (in FIG. 5) instead of at 202. The lignin B is subjected to a carbonization process at 204, for example in the same manner as described for lignin A. The carbonized lignin B is then optionally subjected to deashing and drying at 214 in any suitable manner. By way of example only and without limitation, the carbonized lignin B could be washed with 2M HCl, rinsed to ensure the removal of any HCl residue, and then dried e.g. in a convection oven at an elevated temperature, e.g. in the range of about 80° C. to about 120° C. including any temperature therebetween, e.g. 85, 90, 95, 100, 105, 110 or 115° C. The de-ashed and dried char produced from lignin B is then fed to activation step 206 as described above.

As illustrated with reference to FIG. 4, in some embodiments in which the high-lignin feedstock is black liquor, the black liquor is optionally supplied at 216 (in FIG. 5) instead of at 202. The black liquor is subjected to a pressurized hydrothermal carbonization by heating under a carbonizing atmosphere (e.g. CO₂) under pressure. By way of example only and without limitation, the black liquor can be saturated and then pressurized (e.g. at a pressure in the range of 30-80 psig including any value therebetween, e.g. 40, 50, 60 or 70 psig) at room temperature. The CO₂-pressurized black liquor can be heated at a temperature in the range of about 200-320° C. (including any temperature therebetween, e.g. 210, 220, 230, 240, 250, 260, 270, 280, 290, 300 or 310° C.) at a pressure in the range of about 900-1500 psig (including any value therebetween e.g. 1000, 1100, 1200, 1300 or 1400 psig) for a period of about 2-10 hours (including any period therebetween e.g. 3, 4, 5, 6, 7, 8 or 9 hours) at 218. The resultant product (hydrochar) can be recovered using vacuum filtration at 220. By way of example only, the recovered product can be washed at 220 with 2M HCl to remove any salts (e.g. sodium carbonate), then rinsed with water and dried in a convection oven at an elevated temperature, e.g. in the range of about 80° C. to about 120° C. including any temperature therebetween, e.g. 85, 90, 95, 100, 105, 110 or 115° C., before being supplied to activation step 206.

After activation step 206, an acid washing and drying step is optionally carried out at 222 to remove any residual activating agent, for example in embodiments in which a chemical activating agent was used. For example, where potassium hydroxide is used as an activating agent as in the illustrated embodiment, a water wash can be used to recover unreacted and spent potassium hydroxide for regeneration, followed by washing with a strong acid such as hydrochloric acid to remove potassium hydroxide residue and ash, followed by hot water washing to remove residual chloride ion. Any suitable drying conditions can be used to carry out step 222, including ambient conditions. In some embodiments by way of example only, drying is carried out at a temperature in the range of about 70° C.-150° C. (including any value therebetween e.g. 80, 90, 100, 110, 120, 130 or 140° C.). In some embodiments, drying is carried out in any suitable apparatus such as an oven, convection oven or vacuum oven for a period between 10 and 48 hours (including any period therebetween e.g. 24 or 36 hours). In some embodiments, drying is carried out under atmospheric pressure. In some embodiments, drying is carried out under vacuum, e.g. at a pressure in the range of about 10 to about 760 mmHg.

Optionally, the resultant activated carbon is subjected to micronization or size reduction at 224, for example by grinding with a ball mill, jet mill, grinder or other suitable apparatus. In some embodiments, the average particle size of the activated carbon subsequent to micronization at step 224 is in the range of about 1 μm to about 10 μm, including any value therebetween e.g. 2, 3, 4, 5, 6, 7, 8 or 9 μm. In one embodiment, the activated carbon is ground to a size in the range of about 1 μm to about 10 μm, with a mean size of 6 μm.

After drying, at 226 the activated carbon is subjected to a sweeping gas process at elevated temperature. In some embodiments, the sweeping gas process is carried out using a reducing gas in combination with an inert gas. Examples of gas that may be used as a reducing gas include hydrogen, ammonia, carbon monoxide, forming gas, syngas, or the like. Forming gas is a mixture of hydrogen and nitrogen known in the art. Syngas is a mixture of carbon monoxide and hydrogen known in the art. Examples of inert gas include nitrogen, helium and argon.

In some embodiments, the gas used to carry out the sweeping gas process contains between about 80% to about 99% inert gas, including any value or subrange therebetween e.g. 82, 84, 86, 88, 90, 91, 92, 93, 94, 95, 96, 97 or 98% inert gas, and between about 1% to about 20% reducing gas, including any value or subrange therebetween e.g. 2, 3, 4, 5, 6, 7, 8, 9, 10, 11, 12, 13, 14, 15, 16, 17 or 18%. In some embodiments, the gas used to carry out the sweeping gas process contains between 90-96% inert gas and 4-10% reducing gas. In some embodiments, the sweeping gas contains 96% argon and 4% hydrogen.

In some embodiments, the activated carbon mixture is provided to the sweeping gas treatment as a thin layer of solids, for example spread on a tray. In some embodiments, the activated carbon mixture is held stationary during the sweeping gas treatment.

In some embodiments, the sweeping gas is applied at a superficial velocity of approximately 3.5 to 7.5 cm/minute at atmospheric pressure, including any value therebetween e.g. 4.0, 4.5, 5.0, 5.5, 6.0, 6.5, or 7.0 cm/minute. The superficial velocity at which the sweeping gas is applied can be adjusted by one skilled in the art depending on the type of apparatus used to carry out the process. Step 226 can be carried out in any suitable apparatus, e.g. a tube furnace, rotary kiln, fluidized bed reactor or other suitable apparatus can be used in various embodiments.

In some embodiments, the sweeping gas is sprayed over or through the activated carbon material at step 226. In some embodiments, a sufficient amount of the sweeping gas is supplied to the activated carbon material so that there is a molar excess of hydrogen gas relative to the number of oxygen functional groups in the activated carbon.

In some embodiments, the sweeping gas process at 226 is conducted at an elevated temperature, and the elevated temperature is a temperature in the range of between about 750° C. and about 950° C., including any value or subrange therebetween, e.g. 775, 800, 825, 850, 875, 900, 925 or 950° C. In some embodiments, the sweeping gas treatment is conducted for a period between about 0.5 hours and about 9 hours, including any value or subrange therebetween, e.g. 0.6, 0.7, 0.8, 0.9, 1.0, 1.1, 1.2, 1.3, 1.4, 1.5, 1.6, 1.7, 1.8, 1.9, 2.0, 2.5, 3.0, 3.5, 4.0, 4.5, 5.0, 5.5, 6.0, 6.5, 7.0, 7.5, 8.0, or 8.5 hours.

In some embodiments, the resulting activated carbon product has a carbon content of at least about 90%, including between about 90% and about 99%, including any value therebetween, e.g. 91, 92, 93, 94, 95, 96, 97 or 98%.

In some embodiments, the resulting activated carbon product has a surface area as determined using nitrogen gas adsorption of at least 2500 m²/g, including at least 2600, 2700, 2800, 2900, 3000, 3100, 3200 or 3300 m²/g. In some embodiments, the resulting activated carbon product has a pore volume measured using nitrogen gas adsorption of at least 0.8 cc/g, including at least 0.85, 0.90, 0.95, 1.00, 1.05, 1.10, 1.15, 1.20, 1.25, 1.30, 1.35 or 1.40 cc/g. In some embodiments, the resulting activated carbon product has an iodine value of at least 2500 mg/g, including at least 2550, 2600, 2650, 2700, 2750, 2800, 2850, 2900, 2950, 3000, 3050, 3100, 3150, 3200, 3250, 3300, 3350 or 3400 mg/g.

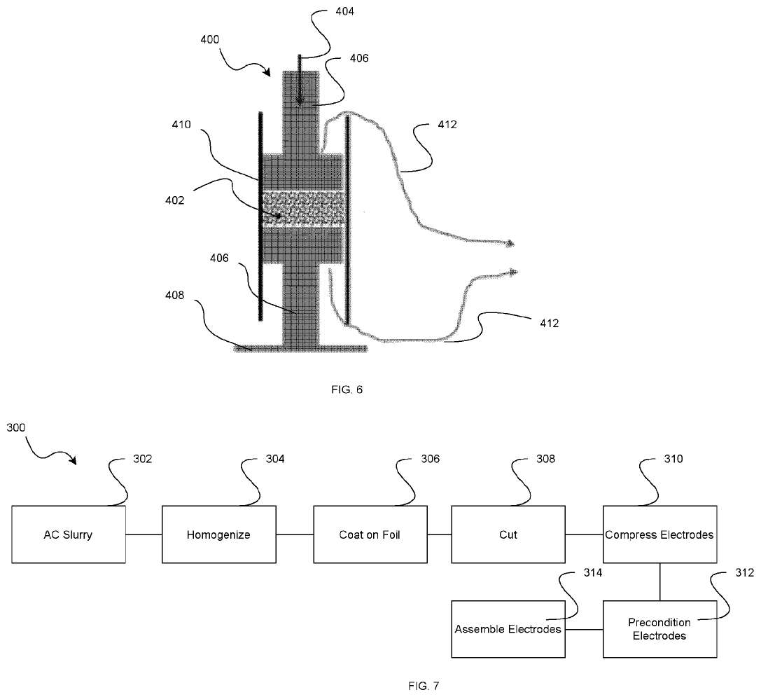

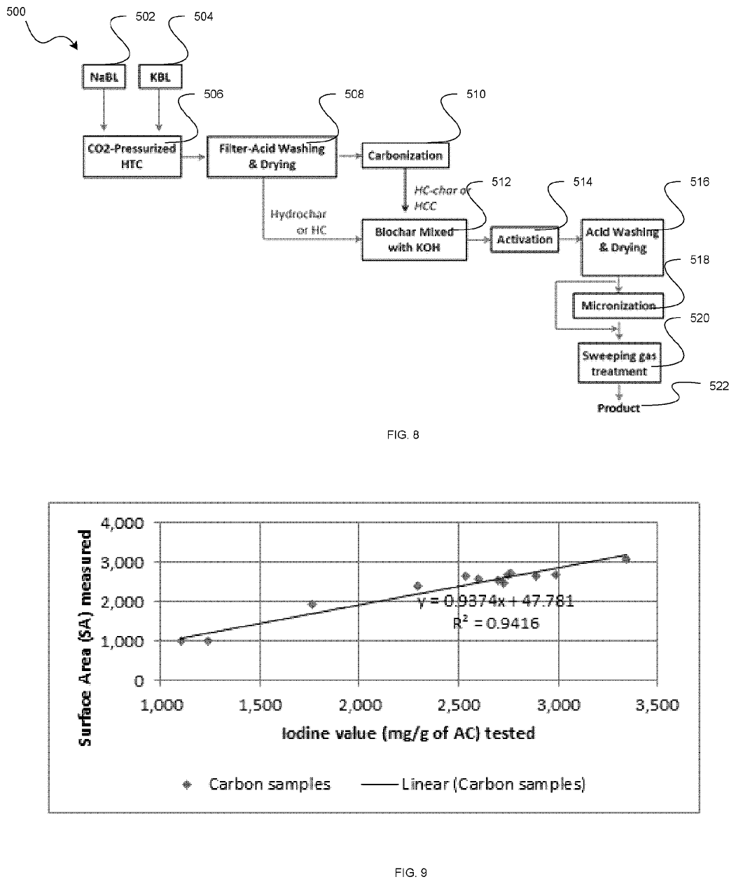

In some embodiments, the activated carbon products described herein are incorporated into electrodes. FIG. 7 shows an example embodiment of a method 300 for fabricating an electrode using activated carbon. At 302, an activated carbon slurry is prepared using the activated carbon, and a binder (e.g. PVF, polyvinylidenedifluoride) in a suitable solvent (e.g. N-methyl pyrrolidone, NMP). Optionally a conductivity enhancer such as graphite is added. At 304 the slurry is homogenized in any suitable manner, for example by sonication. At 306, the resultant slurry is coated on a suitable foil, e.g. aluminum foil, in any suitable manner (e.g. using a coating machine).

At 308, the electrodes are cut from the coated foil, and at 310 the electrodes are hot compressed using any suitable apparatus, e.g. a Carver lab press, e.g. by first heating the electrode to a suitable temperature such as 200° C. and then compressing the electrode e.g. at 100 MPa. At 312, the electrodes are preconditioned, for example by placing at 150° C. in a vacuum oven overnight. At 314, the electrodes are assembled, for example using an airtight button cell (e.g. CR2032 coin cells with a Swagelok) in an inert atmosphere, e.g. an argon-filled glove box. Two electrodes can be placed in the cell with a suitable separator positioned between them and the electrolyte can be added.

Other methods of fabricating electrodes are known to those skilled in the art and could be used in other embodiments, and the foregoing description provides guidance as to one exemplary method of fabricating electrodes and is not limiting.

In some embodiments, electrodes fabricated from activated carbon materials as described herein are incorporated into solid-state lithium batteries, e.g. lithium-sulphur batteries. In some embodiments, activated carbon materials as described herein are incorporated into capacitors or supercapacitors.

In some embodiments, electrodes fabricated from activated carbon materials as described herein are incorporated into structures and/or components of building structures for energy storage. In some embodiments, energy storage systems incorporating activated carbons prepared as described herein may offer a higher energy density than materials fabricated from conventional activated carbons, may offer a lower risk of heat buildup within a building component or a building structure than materials fabricated from conventional activated carbons, may offer a greater number of charge and discharge cycles than materials fabricated with conventional activated carbons, and/or may offer faster charging rates than materials fabricated with conventional activated carbons.

In some embodiments, energy storage systems fabricated using activated carbons as described herein are embedded into modular building components, for example panels that can be used as interior or exterior cladding for buildings, flooring, roofing, countertops, stairs or a staircase, cabinetry, or other building components. In some embodiments, the modular building components incorporate at least one supercapacitor or at least one battery having electrodes fabricated from an activated carbon material as described herein.

In some embodiments, the energy storage system is permanently incorporated into the modular building component, for example by being integrally cast within the modular building component when the modular building component is fabricated or by being permanently secured therein. In some embodiments, the energy storage system is removably incorporated into the modular building component, for example by being inserted within a compartment within the modular building component that is accessible via an access door, access panel, or other detachable or removable covering structure.

In some embodiments, the energy storage system fabricated using activated carbons as described herein is installed within a building structure during construction or erection of the building structure. The energy storage system can be incorporated into any desired part of the building structure during construction, for example a portion of the building structure that will minimize interference with the ordinary usage of the building structure, e.g. the walls, floors, ceilings or internal components thereof.

Providing a removably incorporated energy storage system allows for removal of the system for repair or replacement in the event of failure or once the energy storage system has reached the end of its useful service life. In embodiments in which the energy storage system is permanently installed, if a particular energy storage system fails or reaches the end of its useful service life, use of that particular energy storage system may be discontinued and/or that particular energy storage system may be disconnected from other energy storage systems while the physical energy storage unit remains in situ within the building structure.

In some embodiments, the energy storage system or modular building components incorporating the energy storage system are installed within a warehouse or other building structure that is of a relatively large size while not having a significant concentration of people generally situated therein (e.g. as would be the case with an office tower or residential building structure).

Individual energy storage systems that are integrated into modular building components or into buildings directly may be interconnected to one another and to the main electricity supply grid in any manner. For example, appropriate connectors and cables can be incorporated into the modular building components or into building structures to allow individual energy storage systems to be interconnected.

Depending on the particular situation in which an energy storage system is deployed, the thermal properties of the modular building component or portion of the building into which the energy storage system is incorporated can be selected. For example, in embodiments in which the energy storage system is deployed in modular building panels that also serve an insulating function, the material of the modular building panel or building component can be selected to be thermally insulating. In alternative embodiments, the material of the modular building panel or building component can be selected to be thermally conductive, to allow heat to be transferred away from the energy storage system contained therein.

In embodiments in which a surface of the modular building component or portion of the building into which the energy storage system is incorporated is to be exposed to external elements, then at least that surface of the modular building component or portion of the building that is exposed to the external elements should be weatherproof (i.e. able to withstand rain, snow, wind, sun, and other weather conditions to which it may be exposed).

In embodiments in which the energy storage systems are incorporated into modular building components, then the modular building components can be provided with any appropriate surface configuration, connectors and/or fasteners to allow assembly of the modular building components into a building structure. Any of the variety of available modular building systems could be used for this purpose. In some embodiments, the connectors or fasteners that are incorporated into the modular building components can also serve as electrical connectors, to connect the contained energy storage system to the main electrical system of the building structure.

### EXAMPLES

Certain embodiments are further described with reference to the following examples, which are intended to be illustrative and not limiting in scope.

### Example 1—Sweeping Gas Technique for Carbon Enhancement in Activated Carbon

In this example, activated hydrochar (AHC) as a source of activated carbon was purified and treated to reduce its electrical resistance for electrode preparation. The process involved sweeping gases across a bed of activated hydrochar under reducing conditions at temperatures of 800° C. for one hour. The sweeping gases include an inert gas such as argon and a reducing gas such as hydrogen. In one test, the sweeping gas used was a 96% argon and 4% hydrogen by volume blend.

Table 1 shows the chemical, physical, and electrochemical properties of activated hydrochar (sample N6) compared to additional treatments using Ar inert gas and a sweeping gas (SG) containing 4% H₂ gas and 96% Ar gas respectively. The results demonstrate the improvements to the properties of the activated hydrochar through the use of the sweeping gas technique.

In this example, N6 activated hydrochar was produced from black liquor containing lignin through hydrothermal carbonization using carbon dioxide pressurization and potassium hydroxide activation at elevated temperature. N6 activated hydrochar is a fine powdery material containing 85.28% carbon content. Its iodine value (indicating its micro-pore volume which is reflective of the degree of activation on carbon samples) was 2,701 m²/g, significantly higher than the benchmark activated carbon (YP50F obtained from Calgon).

N6-1hrAR (N6 AHC treated with Ar for 1 hr) showed slightly increased carbon content (91.06%) and iodine value (2,916 mg/g) while N6-1hSG (N6 AHC treated with a reducing sweeping gas (96% Ar, 4% H₂) for 1 hr) revealed significantly increased carbon content (97.19%) and iodine value (3,345 mg/g). N6-1hrSG had a surface area of 3,076 m²/g which is significantly higher than the surface area of the benchmark activated carbon. N6-1hrSG has also significantly higher micro-pore volume (1.106 cc/g) compared to the benchmark (0.685 cc/g). The carbon content of the benchmark activated carbon was previously determined to be 99.24%, whereas the benchmark SG-treated activated carbon was higher than 99.9%.

The treated activated hydrochar material was then used to construct supercapacitor samples. The capacitance of N6-1hrSG supercapacitor (supercapacitor fabricated with activated hydrochar that has been subjected to the sweeping gas processing for one hour) is significantly better than the benchmark activated carbon supercapacitor constructed in a similar fashion. N6-1hrSG supercapacitor achieved high performance (156.5 F/g at 0.5 A/g and 143.2 F/g at 5.0 A/g) compared to the benchmark SG-treated activated carbon product (83.5 F/g at 0.5 A/g and 26.1 F/g at 5.0 A/g). Additionally, the capacitance retention (capacitance generated from a fast charge divided by capacitance generated from a slow charge) of N6-1hrSG supercapacitor is 91%. This is much higher than the benchmark product (YP50F+SG) capacitance retention, which was only 33%. This indicates the N6-1 hrSG supercapacitor has a very low internal resistance. Additionally, the N6-1hrSG supercapacitor with 90% activated carbon and 10% binder (no graphite used) achieved 122.3 F/g with 85% capacitance retention.

Without being bound by theory, it is believed that the reducing gas (e.g. hydrogen gas) in the sweeping gas treatment process is effectively reactive with oxygen to remove oxygen from the carbon. Table 1 shows hydrogen gas in sweeping gas reacted with the oxygen chemically bound in the activated hydrochar, thereby removing a significant electrically insulating component of the activated hydrochar. Without being bound by theory, this is believed to result in increased carbon content and an improved degree of activation (and capacitance). Further, because activated hydrochar produced from black liquor contains a significant proportion of lignin, it is soundly predicted that similar treatment processes will likewise have a positive effect on the properties of other forms of activated carbon produced from lignin or high-lignin materials.

Activated hydrochar samples were reduced with a sweeping gas containing 4% hydrogen gas (H₂), and this was found to reduce resistance and increase the carbon content of the final product. Results are shown in Table 2. Commercially purchased graphite from MTI, referred to as MTI graphite, was used for comparison purposes.

TABLE 1
Measured parameters of activated hydrochar (treated and untreated with the sweeping gas technique) and benchmark activated carbon.

| | Electrode formula | Carbon content (%) | | | Micro-pore volume |
|---|---|---|---|---|---|
| | (% activated | in active carbon | Iodine value (mg | Surface area (m2/g) | (cc/g) measured |
| | carbon:% graphite:% | using combustion | of iodine absorbed | measured using N2 | using nitrogen gas |
| Description of electrode | binder) | method | per g) | gas adsorption | adsorption |
| N6AHC: Hydrochar mixed with | 80%::10%:10% | 85.28% | 2,701 | 2,556 | 0.931 |
| KOH (1:3 mass ratio) using a ball | | | | | |
| mill process and then activated at | | | | | |
| 750° C. for 0.5 hrs under Ar gas | | | | | |
| N6AHC + Ar: N6 AHC treated with | 80%::10%:10% | 91.06% | 2,916 | 2,984 | 1.087 |
| Ar gas at 800° C. for 1 hr | | | | | |
| N6AHC + SG: N6 AHC treated with | 80%:10%:10% | | | | |
| sweeping gas (containing 4% H2 | 90%:0%:10% | 97.19% | 3,345 | 3,076 | 1.106 |
| and 96% Ar gas) at 800° C. for 1 hr | | | | | |
| Benchmark AC(activated carbon, | 80%:10%:10% | 97.67% | 1,821 | 1,810 | 0.679 |
| YP50F) | | | | | |
| Benchmark AC + SG (YP50F treated | 80%:10%:10% | 99% | 1,970 | 1,876 | 0.709 |
| with SG) | | | | | |

| | Performance of supercapacitor fabricated using the formula | | | |
|---|---|---|---|---|
| | Internal | Capacitance | Capacitance | |
| | resistance | (Farad/g) at | (Farad/g) | Capacitance |
| Description of electrode | (mΩ-g) | 1 A/g | at 10 A/g | retention (%) |
| N6AHC: Hydrochar mixed with | 278 | 113.6 | Not able | N/A |
| KOH (1:3 mass ratio) using a ball | | | to charge | |
| mill process and then activated at | | | | |
| 750° C. for 0.5 hrs under Ar gas | | | | |
| N6AHC + Ar: N6 AHC treated with | 212 | 132.5 | Not able | N/A |
| Ar gas at 800° C. for 1 hr | | | to charge | |
| N6AHC + SG: N6 AHC treated with | 22 | 156.5 | 143.2 | 91% |
| sweeping gas (containing 4% H2 | 90 | 122.3 | 122.3 | 85% |
| and 96% Ar gas) at 800° C. for 1 hr | | | | |
| Benchmark AC(activated carbon, | Not | Not | Not | Not |
| YP50F) | tested | tested | tested | tested |
| Benchmark AC + SG (YP5OF treated | 61 | 83.6 | 26.1 | 31% |
| with SG) | | | | |

TABLE 2
Effects of Different Preparation Methods on Alternative Current Resistance.

| | Normalized ACR | Relative | | |
|---|---|---|---|---|
| | per 10 mg sample | resistance | Carbon | Ash |
| | (Ω/10 mg at 100 | based on | content | content |
| Carbon ID | kHz) | Comparison 2 | (%) | (%) |
| S25AHC: Coarse activated | 0.023 | 578% | 90.03% | 2.71% |
| hydrochar (AHC) produced | | | | |
| using hydrochar derived from | | | | |
| black liquor | | | | |
| S25AHC + SG: S25AHC reduced | 0.009 | 227% | 94.95% | 2.64% |
| using SG at 800° C. for 1 hr | | | | |
| S12AHC: Fine activated | 0.016 | 403% | 88.32% | 2.40% |
| hydrochar (AHC) | | | | |
| S12AHC + SG: S12AHC reduced | 0.008 | 213% | 97.19% | 2.25% |
| using SG at 800° C. for 1 hr | | | | |
| WBC: Wood based hydrochar | Non-conductive | N/A | 91.09% | 0.39% |
| produced at 550° C. for 1 hr | | | | |
| WBC + SG: WBC reduced using | 0.009 | 221% | 99.18% | 0.74% |
| SG at 800° C. for 1 hr | | | | |
| Comparison 1: Nano particle | 1.221 | 31338% | >99% claimed | N/A |
| black carbon (Sigma-Aldrich) | | | | |
| Comparison 2: Graphite (MTI) | 0.004 | 100% | >99.8% claimed | N/A |

### Example 2—Further Refinement of Lignin-Based Activated Carbon as Electrode Materials

### Materials and Methods

This work utilized the following lignin-based feedstocks which were carbonized and activated. Black liquor was obtained from a pulp mill, which processes wood pulp. Both samples of lignin A and lignin B were extracted from kraft pulping process and isolated using the LignoForce™ process.
Black liquor (BL): A BL sample was obtained from a lignin recovery plant. BL contains dissolved lignin which is left in the produced black liquor as a pulp production industry byproduct. The recovery plant uses BL to recover lignin A (primary) and lignin B.
Lignin A (denoted as LA): was extracted from the Kraft pulping process and recovered using the LignoForce™ process.
Lignin B (denoted as LB): was also extracted from Kraft pulping process and recovered using the LignoForce™ process but is considered a lower grade of lignin.

Additionally, a benchmark activated carbon was selected for comparison purposes. Coconut shell derived AC was obtained from Calgon. The following AC was used as a benchmark to compare the electrochemical properties over lignin-based ACs: YP50F, Calgon: denoted as YPAC.

### Carbonization and Activation

FIG. 5 shows the overall production process for lignin-based activated carbons from LA, LB, and BL using carbonization or hydrothermal carbonization (HTC), followed by standard KOH activation, de-ashing (removal of ash from hydrochar using acidic washing)-drying, and finally the SG treatment.

Briefly, the main carbonization pathway (top pathway in FIG. 5) was conducted at 550° C. for 1 hr for LA and LB samples to produce LA and LB char, respectively. The LA char was then activated at 800° C. for up to 2 hrs using KOH. The LB hydrochar was first de-ashed and then activated to produce LBAC (see the middle pathway at step 214 in FIG. 5).

For activated hydrochar (AHC) production using hydrothermal carbonization, the BL sample was placed in a pressurized reactor and the reactor was saturated and pressurized with CO₂ at 50 psig at room temperature. This pressurization and the subsequent reaction was heated to a temperature of 280° C. (resulting in a pressure increase to in the range of 900-1000 psig) that was sustained for up to 5 hrs producing a hydrochar. The collected hydrochar was then activated at 800° C. for up to 2 hrs using KOH.

The collected LAAC, LBAC, and AHC were washed with water to recover KOH (which can be used for the next KOH-activation batches) and then rinsed with 2M HCl to ensure the removal of unreacted KOH and ash, followed by hot water washing for residual chlorine removal. This hot water washing was conducted until the filtrate no longer showed a white cloudy point when a few drops of 0.5% AgNO₃ solution was added. This final material was then dried in a convection oven at 105° C. overnight for the SG treatment.

### Micronization and Sweeping Gas Treatment

If size reduction is desired, the dried biocarbon products can be comminuted and/or micronized in any suitable manner, such as using a planetary ball mill or a jet mill (in this work, the particle sizes of lignin A and lignin B produced (about 17.8 μm after activation) were sufficiently small that further size reduction was not used to test supercapacitors, although smaller particle sizes approaching e.g. 5 μm may be desirable for commercial applications) and then subject to the sweeping gas treatment, which flushed the carbon with a gas mixture containing 90% nitrogen and 10% hydrogen under high temperatures. This final post-treatment method after the activation removes the oxygen groups chemically bound to the lignin-based activated carbon. By reacting/stripping the bound oxygen with the sweeping gases at high temperatures, the SG-treated biocarbon products were altered to yield lower electrical resistance, higher carbon content, and improved surface area properties. In this work, the sweeping gas treatment used the following conditions:
Sweeping gas (10% H₂ and 90% nitrogen gas (N₂)) flow across a static and thin layer of solids on a tray in a furnace which has a superficial velocity of 5.5 cm³/min (or 1 L/min in a 6″ tube) at 800° C. for 3 hrs

### Chemical Analyses

Lignin content: The lignin content was determined by precipitating the lignin under low pH. In this case, the BL sample was lowered to <pH 3.5 (Ahvazi, 2016), and the precipitated lignin was then filtered and dried in a 105° C. oven overnight to measure the dry matter lignin content.
Recoverable lignin content (acid insoluble lignin) was measured by the following procedure (based on a method described in Haz's study (Haz, et al, 2019)): A specific amount (W1) of the as-received black liquor (BL) was placed in a beaker. 2M-HCl solution was added in the prepared beaker until pH reached 1.5 where lignin is precipitated in the bottom. The resultant solution was filtered using a filter paper (201, Whatman) which was pre-weighed (W2). The collected solids on the filler paper was washed with hot water and dried in an oven at 105° C. until the mass became constant. The dried filter paper (solids+filer paper) was weighed (W3). Recoverable lignin content (%) in the as-received black liquor was calculated using the following equation:

Recoverable lignin content(%,wet basis) in as-received BL=(W3−W2)×100/W1
Dry matter (DM) content (% by mass and on a wet basis) in the as-received black liquor. A specific amount (W4) of the as-received black liquor (BL) was collected on a watch glass which is pre-weighed (W5). The prepared watch glass was air-dried at room temperature until free-water evaporated. The air-dried watch glass was dried in an oven at 105° C. until the mass became constant. The dried watch glass (solids+watch glass) was weighed (W6). DM content (%) in the as-received black liquor was calculated using the following equation:

DM content(%,wet basis or w.b.) in as-received BL=(W6-W5)×100/W4
Water content in the as-received black liquor. Water content (%) in DM was calculated using the following equation:

Water content(%)=100−DM(%,w.b.)
Recoverable lignin content (%) in DM. Lignin content (%) in DM was calculated using the following equations:

Dry matter(DM)content(%,w.b.)=Recoverable lignin content(%,w.b.)+Non-lignin content(%,w.b.)

Recoverable lignin content(%,dry basis) in DM=Recoverable lignin content (%)/DM content(%,w.b.)
Carbon and sulphur analyses: Carbon and sulphur content was measured on the dry carbon samples using an elemental analyzer. The solid sample was converted to oxidized forms and these oxidized gases were quantified by an infrared detector for the determinations of carbon and sulphur content (by mass) in the solid sample.
Ash analysis: Ash content in the collected samples was measured by mass. The dry solid sample was combusted in a Muffle furnace at 580° C. overnight and the residual ash was collected and weighed to determine ash content.

### Morphological Analyses

Determination of Iodine number: Iodine number (mg of iodine adsorbed per g of activated carbon) provides the most fundamental property for activated carbon performance because the Iodine number represents the actual micro-pore volume in the activated carbon. The determination of iodine number is a standard measurement for liquid phase applications (Marsh, 2006). In this study, the iodine number is regularly used for assessing the suitability of activated carbon for carbon electrode materials.
BET Surface area analysis using N₂ adsorption: Specific surface area of carbon samples was determined by the Brunauer, Emmett, and Teller (BET) theory of nitrogen multilayer gas adsorption behavior using multipoint determinations. In this technique, the total pore volume of the solid sample is determined based on the results of gas saturation at a single point.
Pore size distribution (PSD): This was calculated using SAIEUS Non Local Density Functional Theory (NLDFT) Analysis software developed by Micromeritics. NLDFT can average and smooth out adsorption energy density on subsequent adsorbed layers and uses integral equations to determine the density of adsorbed molecules as a function of distance from the adsorbent wall (Kupgan, 2017).

### Electrical Resistance

FIG. 6 illustrates the electrical resistance test apparatus 400 utilized on the powdered activated carbon samples 402. Compression 404 was applied using a pair of copper pistons 406 having a flat base 408, and the powdered activated carbon sample 402 was contained within a non-conductive cylinder 410. Copper wires 412 were connected to a resistance meter to measure resistance. This test functioned as a screening tool for the selection of carbon product samples that warranted further use as electrode material in supercapacitors. A specific amount of a carbon sample was placed in the chamber and electrical resistance was measured while the carbon sample was compressed at 45 MPa. The measured resistance was correlated to a relative alternating current resistance (% ACR) based on the resistance of graphite (obtained from MTI Corp., USA), which is commonly used as a conductive agent. The relative ACR of the carbon sample was then compared with the benchmark YPAC activated carbon.

### Example 3—Fabrication and Testing of Electrodes for a Supercapacitor

FIG. 7 presents the overall fabrication of supercapacitors with lignin-based AC electrodes tested in this example. The AC slurry was prepared using 75-80% AC, 10% graphite, and 10-15% binder and NMP (a mass ratio of 1 solid:2.5 NMP or 1 solid:2 NMP) which were homogenized through a high energy sonication. The AC slurry was coated on an aluminum foil using a coating machine. The coated Al foil was dried at 80° C. in a vacuum oven overnight. The dried Al foil was circled out to 15.0 mm in diameter. The resulting electrode was calendered at 200° C. for 2 minutes and immediately compressed at 100 MPa. The compressed electrode was preconditioned at 150° C. in a vacuum oven overnight and then the electrode was placed in an Ar-filled glove box for supercapacitor assembly. The electrode was assembled in the Ar-filled glove box using an airtight button cell (CR2032). Two identical electrodes were placed in the cell. The separator (Celgard, 25 μm) was placed between two electrodes. The electrolyte (100 μL) for this cell assembly was used. The electrode contains 1.5 M of Tetraethylammonium tetrafluoroborate (the most common organic electrolyte) dissolved in acetonitrile.

### Performance Testing of Capacitors—Capacitance

Galvano charge-discharge (GCD) tests were conducted to determine the specific capacitance of the supercapacitor (tested from a slow charge and discharge (CD) rate of 0.5 A/g to a fast CD rate of 5.0 A/g). The GCD measurements used potential ranging from 0 to 2.3 V at various current densities ranging from 0.5 A/g to 5 A/g. The discharge capacitance was calculated using the following equations.

Specific capacitance(Cₛₚ,F/g)=4|dt/mₜdV Equation 1

Discharge rate(A/g)=l/mₜ Equation 2

### Where:

Cₛₚ=The specific capacitance (F per gram of the active material)
I=Applied current (A)
dₜ=Discharge time (sec), not include switching time between the last point of the charge mode and the starting point of the discharge
mₜ=Total mass of active material on two electrodes (g)
dV=The voltage difference (V) from the last point of charge to the endpoint of the discharge voltage at 0 volt

### Example 4—Evaluation of Raw Material Characteristics

### Raw Material Analysis

Table 3 summarizes the major elemental and ash content in the three lignin-based materials that were used to produce lignin-based activated carbons. Lignin A, B, and BL-derived lignin (lignin collected from the black liquor) had high carbon of >63% (65.7%) and a low ash content of <1.47%, while LB had a low carbon content (54.6%) and a high ash content (26.24%), which is not suitable to produce high quality activated biocarbon. All lignin sources for these experiments had higher than 73.4% lignin content on a dry matter basis (by weight).

TABLE 3
Major element and ash content in lignin A,
lignin B, and recoverable lignin in BL.

| | Total lignin | | | |
|---|---|---|---|---|
| | content* | | | |
| | (*recoverable | | | |
| | lignin for black | Carbon | Sulphur | Ash |
| Raw materials | liquor) | content | content | content |
| Lignin A (LA) | 96.0% | 65.70% | 2.49% | 1.47% |
| Lignin B (LB) | 73.4% | 54.60% | 1.94% | 24.70% |
| BL-derived lignin (lignin | 96.3% | 63.47% | 3.29% | 0.45% |
| collected from black | | | | |
| liquor) | | | | |

*Note:
Recoverable lignin content in black liquor was calculated by the following equation: lignin content(%) = 100% − (sulfur % + ash content %).

Table 4 shows the black liquor contained dissolved recoverable lignin (12.5% by weight) which was collected using 2M-HCl addition at pH 1.5. The as-received black liquor (which has undergone multi-evaporation processes to use for the recovery of lignin at the lignin recovery pant) had a dry matter content of 43.8% and a water content of 56.2%, which is a viscous slurry.

TABLE 4
Major element and ash content in black liquor feedstocks.

| pH | | >13.5 |
|---|---|---|
| Water | | 56.2% |
| Dry matter content | | 43.8% |
| Dry matter | Non-lignin | 31.2% [71% of |
| content (43.8%) | content | dry matter] |
| | Recoverable | 12.5% [29% of |
| | lignin content | dry matter] |

### Chemical and Adsorptive Properties of Activated Carbon Products

Table 5 summarizes the major key indicators of lignin-based ACs compared to the benchmark YPAC before and after the SG treatment. Lignin-based ACs had an iodine number of 2,526-2,998 mg/g, carbon content of 88.3 to 92.6%, and ash content of 1.07-2.4% while YPAC has an iodine number of 1,865 mg/g, carbon content of 99.24%, and ash content of 0.35%.

After these lignin-based ACs and YPAC were treated with sweeping gas, the values of all the major key indicators increased. The sweeping gas treated lignin-based ACs had an iodine number of 2,875-3,345 mg/g, carbon content of 97.03-98.1%, and ash content of 1.07-2.4%, and ash content of 1.07%-3.10%. The most key indicators of YPAC+SG increased to be an iodine value of 2,048 mg/g, carbon content of 99.0%, and ash content of 0.38%.

TABLE 5
Iodine values, carbon and ash content of ACs (before and after SG treatment).

| | | | | Iodine | | |
|---|---|---|---|---|---|---|
| | | | Post treatment | # | | |
| AC ID | | Type of raw material | after activation | (mg/g) | Carbon % | Ash % |
| Lignin- | AHC | Lignin from black liquor | None | 2,701 | 88.32% | 2.40% |
| based AC | (activated | | | | | |
| | hydrochar) | | | | | |
| | AHC + SG | Lignin from black liquor | treated with SG | 3,345 | 97.19% | 2.25% |
| | LAAC | Lignin A | None | 2,998 | 92.59% | 1.07% |
| | LAAC + SG | Lignin A | treated with SG | 3,140 | 98.10% | 0.68% |
| | LBAC + SG | Lignin B | None | 2,526 | 89.47% | 1.28% |
| | LBAC + SG | Lignin B | treated with SG | 2,875 | 97.03% | 3.10% |
| Comparison | YPAC | Coconut shell | None | 1,865 | 99.24% | 0.35% |
| | YPAC + SG | Coconut shell | treated with SG | 2,048 | 99.00% | 0.38% |

Notes:
1. Lignin A and lignin B were obtained from a lignin recovery plant.
2. Lignin A is the primary lignin product from the lignin recovery plant.
3. Lignin B was carbonized and de-ashed prior to the activation for LBAC production.

### Electrical Properties of Activated Carbon Products

Table 6 summarizes electrical resistance data on lignin-based ACs in comparison with YPAC. The SG treated lignin-based ACs improved all chemical and electrical properties when compared with YPAC. Lignin-based ACs had a relative electrical resistance of 240%-500% and YPAC has 558% (based on graphite obtained from MTI Co., CA, USA). The SG-treated lignin-based ACs had a relative electrical resistance of 184-340% while YPAC+SG had a relative electrical resistance of 434%.

TABLE 6
Electrical resistance values of ACs (before and after SG treatment).

| | | | | Relative |
|---|---|---|---|---|
| | | | Post treatment | electrical |
| Activated carbon ID | | Type of raw material | after activation | resistance (%) |
| Lignin-based | AHC | Lignin from black | None | 500% |
| AC | | liquor | | |
| | AHC + SG | Lignin from black | Treated with | 340% |
| | | liquor | SG | |
| | LAAC | Lignin A | None | 366% |
| | LAAC + SG | Lignin A | Treated with | 184% |
| | | | SG | |
| | LBAC | Lignin B | None (de-ashed | 240% |
| | | | after | |
| | | | carbonization | |
| | | | and before | |
| | | | activation) | |
| | LBAC + SG | Lignin B | Treated with | 185% |
| | | | SG | |
| Comparison | YPAC | Coconut shell | None | 558% |
| | YPAC + SG | Coconut shell | Treated with | 434% |
| | | | SG | |

### Morphological Properties of Activated Carbon Products

The primary lignin product from the lignin recovery plant is Lignin A. Lignin A was subjected to further evaluation which is believed to be representative of all lignin-based sources including lignin A, lignin B, and BL-derived lignin. Table 7 summarizes BET (Brunauer-Emmett-Teller) surface area of LAAC-based products with detailed porosity data using nitrogen adsorption. The detailed morphological properties of LAAC-based products was compared with YPAC+SG-based products. LAAC had a surface area of 2,728 m²/g, which is significantly higher than YPAC (1,810 m²/g). LAAC had a total pore volume of 1.213 cc/g with a mean pre size of 1.29 nm while YPAC had a total pore volume of 0.829 cc/g with a mean pore size of 1.18 nm.

After sweeping gas treatments of LAAC and YPAC, LAAC+SG and YPAC+SG were increased surface areas of 3,203 m2/g and 1876 m2/g, respectively. The following Table 7 shows the strong correlation between iodine values (mg/g) and BET surface area (m²/g).

TABLE 7
Surface area and porosity of SG-treated LAAC and YPAC.

| | | | | | Pore volume | |
|---|---|---|---|---|---|---|
| | | | | Micro-pore | (cc/g) | Total pore |
| | | BET | | volume (cc/g) | counted from | volume (cc/g) at |
| | Iodine # | surface | Mean pore | counted from | 0 to 50 nm | saturation point |
| Carbon ID | (mg/g) | area (m²/g) | (nm) | 0 to 2 nm | pore size | (end point) |
| LAAC | 2998 | 2,728 | 1.29 | 0.971 | 1.104 | 1.213 |
| LAAC + SG | 3140 | 3208 | 1.13 | 1.031 | 1.333 | 1.334 |
| YPAC | 1865 | 1,810 | 1.18 | 0.679 | 0.743 | 0.829 |
| YPAC + SG | 2048 | 1876 | 1.18 | 0.709 | 0.76 | 0.849 |

NOTES:
Micro- and meso-pore volumes were determined by density functional theory method.
Mean pore size was calculated at 50% cumulative volume of the total pore volume.

### Performance Evaluation of Supercapacitors

Table 8 summarizes initial capacitance values of supercapacitors with lignin-based ACs in comparison to YPAC before and after the SG treatment. Supercapacitors with LAAC and LAAC+SG were assembled, respectively. YPAC and YPAC+SG based supercapacitors were also prepared for comparison. Four (4) cells were assembled in each group. When the worst value of the capacitances in each group was ignored or considered as an outlier due to the hand-made assembly process, LAAC-based supercapacitors achieved a capacitance ranging 155.5 F/g-160.8 F/g at a slow discharge rate of 0.5 A/g and 122.4-136.1 F/g at a fast discharge rate, while LAAC+SG had significantly increased capacitance of 170-176.8 F/g at 0.5 A/g and 141.2-156.7 F/g at 5.0 A/g.

YPAC-based supercapacitors had a capacitance of 76.4-84 F/g at 0.5 A/g and 7.8-20 F/g at 5.0 A/g. YPAC+SG-based supercapacitors performed a similar capacitance to YPAC-based supercapacitors when being tested at a slow discharge rate of 0.5 A/g. YPAC+SG-based supercapacitors had increased capacitance values of 18.3-44.3 F/g at a high discharge rate of 5.0 A/g. Finally, The best cell in each group was selected for further tests.

TABLE 8
Initial capacitance values of supercapacitors with lignin-
based ACs and YPAC with and without SG treatment.

| | | | | | Initial | |
|---|---|---|---|---|---|---|
| | | Slurry formulation | | Discharge | capacitance | |
| Carbon ID | | (AC:graphite:binder) | Cell ID | rate (A/g) | (F/g) | Note |
| Lignin-based | LAAC | 75:10:15 | #52-1 | 0.5 | 158.6 | |
| AC | | | | 5.0 | 136.1 | |
| | | | #52-2 | 0.5 | 160.8 | |
| | | | | 5.0 | 122.4 | |
| | | | #52-3 | 0.5 | 155.5 | |
| | | | | 5.0 | 137.2 | |
| | | | #52-4 | 0.5 | 147.0 | Worst |
| | | | | 5.0 | 88.5 | |
| | LAAC + SG | 75:10:15 | #86-1 | 0.5 | 176.8 | |
| | | | | 5.0 | 156.7 | |
| | | | #86-2 | 0.5 | 170.0 | |
| | | | | 5.0 | 155.3 | |
| | | | #86-3 | 0.5 | 172.3 | |
| | | | | 5.0 | 141.2 | |
| | | | #86-4 | 0.5 | 170.8 | Worst |
| | | | | 5.0 | 146.4 | |
| Comparison | YPAC | 80:10:10 | #17-5 | 0.5 | 76.4 | Worst |
| | | | | 5.0 | 0.0 | |
| | | | #17-6 | 0.5 | 82.6 | |
| | | | | 5.0 | 10.4 | |
| | | | #17-7 | 0.5 | 84.0 | |
| | | | | 5.0 | 20.0 | |
| | | | #17-8 | 0.5 | 80.3 | |
| | | | | 5.0 | 7.8 | |
| | YPAC + SG | 80:10:10 | #20-13 | 0.5 | 77.2 | Worst |
| | | | | 5.0 | 18.3 | |
| | | | #20-14 | 0.5 | 76.4 | |
| | | | | 5.0 | 18.3 | |
| | | | #20-15 | 0.5 | 75.7 | |
| | | | | 5.0 | 33.0 | |
| | | | #20-16 | 0.5 | 81.1 | |

The best 3 cells (based on the highest values of the initial capacitance in each group) were cycled 600 times which were tested at 300 cycles at a slow charge and discharge rate of 0.5 A/g and 300 cycles at a fast charge and discharge rate of 5 A/g. Table 9 summarizes the capacitance values of supercapacitors with LAAC and LAAC+SG in comparison with supercapacitors with YPAC and YPAC+SG after 600 cycle tests.

LAAC based supercapacitors achieved capacitances of 119.4-161.5 F/g at a slow discharge rate of 0.5 A/g and 82.6-140.4 F/g at a fast discharge rate of 5 A/g, while LAAC+SG (164.7-170.7 F/g at a slow discharge rate of 0.5 A/g and 149.3-150.3 F/g at a fast discharge rate of 5 A/g) achieved higher capacitance than LAAC. YPAC+SG (74.2-78.9 F/g at a slow discharge rate of 0.5 A/g and 6.1-31.3 F/g at a fast discharge rate of 5 A/g) had slightly higher capacitance than YPAC (65.2-82.3 F/g at a slow discharge rate of 0.5 A/g and 2.6-19.1 F/g at a fast discharge rate of 5 A/g).

It is clearly shown that the lignin-based ACs had improved adsorptive and electrical properties after the sweeping gas treatment as compared with a control activated carbon made from coconut coir. These improved properties can provide ideal electrode materials for supercapacitors and lithium-sulphur battery applications.

TABLE 9
600-cycled capacitance values of supercapacitors with lignin-
based ACs and YPAC with and without SG treatment.

| | | Slurry formulation | | Discharge rate | Capacitance |
|---|---|---|---|---|---|
| Carbon ID | | (AC:graphite:binder) | Cell ID | (A/g) | (F/g) |
| Lignin- | LAAC | 75:10:15 | #52-1 | 0.5 | 161.5 |
| based AC | | | | 5.0 | 140.4 |
| | | | #52-2 | 0.5 | 153.4 |
| | | | | 5.0 | 99.6 |
| | | | #52-3 | 0.5 | 119.4 |
| | | | | 5.0 | 82.6 |
| | LAAC + SG | 75:10:15 | #86-1 | 0.5 | 170.7 |
| | | | | 5.0 | 150.3 |
| | | | #86-2 | 0.5 | 164.7 |
| | | | | 5.0 | 149.3 |
| | | | #86-3 | 0.5 | 168.6 |
| | | | | 5.0 | 149.8 |
| Comparison | YPAC | 80:10:10 | #17-6 | 0.5 | 65.2 |
| | | | | 5.0 | 2.6 |
| | | | #17-7 | 0.5 | 82.3 |
| | | | | 5.0 | 19.1 |
| | | | #17-8 | 0.5 | 77.1 |
| | | | | 5.0 | 12.2 |
| | YPAC + SG | 80:10:10 | #20-14 | 0.5 | 74.2 |
| | | | | 5.0 | 6.1 |
| | | | #20-15 | 0.5 | 75.0 |
| | | | | 5.0 | 9.6 |
| | | | #20-16 | 0.5 | 78.9 |
| | | | | 5.0 | 31.3 |

### Example 5—Characterization of Activated Carbon Produced from Wheat Straw

Black liquor (BL) obtained from the pulping of wheat straw was used to produce a lignin-based activated carbon that was subjected to a sweeping gas process.

### Hydrothermal Carbonization and Activation

FIG. 8 shows the overall production process 500 for lignin-based ACs from sodium hydroxide based black liquor (NaBL) and potassium hydroxide based black liquor (KBL) using hydrothermal carbonization (HTC) and/or carbonization, followed by standard KOH activation, de-ashing (removal of ash from biochar using acidic washing), drying, and finally the SG treatment.

Briefly, the NaBL 502 and KBL 504 samples were placed in a pressurized reactor and the reactor was saturated and pressurized with CO₂ at 50 psig at room temperature. This pressurization and the subsequent reaction was heated to a temperature of 280° C. (resulting in an increase in pressure to about 900-1000 psig) that was sustained for up to 5-10 hrs producing a hydrochar 506 that was recovered by vacuum filtration at 508, washed with 2M HCl, and dried. The hydrochar was directly activated at 800° C. for up to 2 hrs using KOH added at 512, or the hydrochar was carbonized at 550° C. for 1-3 hrs (to produce HC-char or HCC) at 510. The HCC-char was activated at 800° C. for up to 2 hrs at 514 using KOH added at 512.

The collected lignin-based ACs were washed with water to recover KOH (which can be used for the next KOH-activation batches) and then rinsed with 2M-HCl to ensure the removal of unreacted KOH and ash at 516, followed by hot water washing for residual chlorine removal. This hot water washing was conducted until the filtrate no longer showed a white cloudy point when a few drops of 0.5% AgNO₃ solution were added. Although micronization can optionally be carried out at 518, this step was not included in this example. This final material was then dried in a convection oven at 105° C. overnight for the SG treatment.

### Micronization and SG Treatment

The dried biocarbon products can be micronized using a planetary ball mill or jet mill if desired at 518 (in this work, the micronization was not carried out) and then subject to the sweeping gas treatment at 520, which flushed the carbon with a gas mixture containing 90% nitrogen and 10% hydrogen under high temperatures. This final post-treatment method after the activation removes the oxygen groups chemically bound to the lignin-based activated carbon. By reacting/stripping the bound oxygen with the sweeping gases at high temperatures, the SG-treated biocarbon products were altered to yield lower electrical resistance, higher carbon content, and improved surface area properties in the final product 522. In this work, the SG treatment uses the following conditions: gas flow across a static and thin layer of solids on a tray in a furnace which has a SG superficial velocity (10% H₂ and 90% nitrogen gas) of 5.5 cm/min (or 1 L/min in 6″ tube) at 800° C. for 3 hrs.

### Chemical Analyses

Recoverable lignin content (% by mass and on wet a basis) in the as-received black liquor: Recoverable lignin content (acid-insoluble lignin) was measured by the following procedure (based on a method described in Haz's study (Haz, et al, 2019)) as described above. Recoverable lignin content (%) in DM: Lignin content (%) in DM was calculated using the following equations.

Dry matter(DM)content(%,w.b.)=Recoverable lignin content(%,w.b.)+Non-lignin content(%,w.b.)+ash(%,w.b.)

Recoverable lignin content(%,dry basis) in DM=Recoverable lignin mass(d.b.)/DM mass(d.b.)

Element (carbon, hydrogen, nitrogen, and sulfur) analyses: Major elements were measured in the dry samples using an elemental analyzer. The solid sample was converted to oxidized forms and these oxidized gases (CO₂, H₂O, NO₂, and SO₂) were quantified by an infrared detector or thermal conductivity detector for the determinations of the elements (by mass) in the solid sample, respectively.

Proximate analysis: The proximate analysis determines ash content, volatile matter, and fixed carbon (calculation by the difference). The dry solid sample was combusted in a Muffle furnace at 580° C. overnight and the residual ash was collected and weighed. Ash content in the collected dry matter and the solid sample was calculated by mass. The amount of volatile matter (VM %) was determined by heating the dry solid sample under an inert environment at 950° C. and measuring the mass loss after the heating process. The VM content was calculated by the mass loss based on the original mass of the solid sample. The fixed carbon content was calculated by the following equation: Fixed carbon (%)=100%−(ash %+VM %).

### Morphological Analyses

Determination of Iodine number: Iodine number (mg of iodine adsorbed per g of activated carbon) provides the most fundamental property for activated carbon performance because the Iodine number represents the micro-pore volume in the activated carbon. The determination of iodine number is a standard measurement for liquid phase applications (Marsh, 2006). In this study, the iodine number is regularly used for assessing the suitability of activated carbon for carbon electrode materials.

BET Surface area analysis using N₂ adsorption: Specific surface area of carbon samples was estimated using a correlation (y=0.9374x+47.781, R²=0.9416) between Iodine values and surface area values from previous lignin-based AC samples as presented in FIG. 9.

### Electrical Resistance

Electrical resistance was measured using the experimental apparatus illustrated in FIG. 6. A specific mass of a carbon sample was placed in the chamber and electrical resistance was measured while the carbon sample was compressed at 45 MPa. The measured resistance was correlated to a relative alternating current resistance (% ACR) based on the resistance of graphite (obtained from MTI Corp., USA), which is commonly used as a conductive agent in supercapacitors. The relative ACR of the carbon sample was then compared with the benchmark AC. Electrodes for a supercapacitor were prepared using the method described in FIG. 7. Galvano charge-discharge (GCD) tests were conducted as described above.

Table 10 summarizes dry matter (DM) and recoverable lignin content in NaBL and KBL samples (denoted as NaBL and KBL, respectively). NaBL and KBL had 48.2% and 38.6% for DM and 12.0% and 13.9% for recoverable lignin content, respectively. Non-lignin content including carbohydrates and salts (Na, K, Si, and other mineral salts) was tested to be 36.2% in NaBL and 24.8% in KBL.

TABLE 10
Dry matter and recoverable lignin content on a wet basis.

| Parameters | | NaBL, as-received | KBL, as-received |
|---|---|---|---|
| Dry matter (DM) or | Recoverable lignin | 12.0% | 13.9% |
| solids content (%) | (%, L) content using | (10.6% lignin, | (12.1% lignin + |
| | acidification method | 1.5% salts) | 1.8% salts) |
| 48.2% DM for NaBL and | Non-lignin content | 36.2% | 24.8% |
| 38.6% DM for KBL | | | |

| | | |
|---|---|---|
| Water content (%) | 51.8% | 61.4% |
| SUM | 100.0% | 100.0% |

Notes:
1. Lignin precipitated after acid addition (<pH 2) and collected for lignin content
2. Non-lignin content includes carbohydrates and salts (Na, K, Si, and other mineral salts)

Table 11 shows major elements and ash in dry matter prepared from NaBL and KBL samples. Ash, non-combustible content (%) was tested to be 41.58% in NaBL-derived DM (NaBL-DM) and 36.72% in KBL-derived DM (KBL-DM). Carbon content, the major element in the combustible content in DM was 31.4% in NaBL-DM and 32.3% in KBL-DM (on a dry basis).

TABLE 11
Major elements and ash content in dry matter (on a dry basis).

| Parameters | NaBL-derived DM | KBL-derived DM |
|---|---|---|
| Carbon (%) | 31.40% | 32.3% |
| Hydrogen (%) | 4.17% | 4.29% |
| Nitrogen (%) | 0.62% | 0.64% |
| Sulfur (%) | <0.20% (below | <0.20% (below |
| | reportable limit) | reportable limit) |
| Oxygen (%) | 22.03% | 22.69% |
| Ash (%) | 41.58% | 36.72% |

Note:
Oxygen content was calculated by the following difference: O (%) = 100 − (C % + H % + N % + S %).

Table 12 summarizes carbon sources in dry matter (DM) from NaBL and KBL samples. The NaBL-DM has similar carbon profile to KBL-DM. NaDM and KDM had almost a 1:1 carbon ratio with respect to lignin-C and carbohydrate-C (carbon from acid-insoluble lignin and carbon from carbohydrates). The carbon content of acid-insoluble lignin (16% carbon) was slightly higher than carbohydrate (13.7% carbon) in NaBL-DM, while carbon content of carbohydrates (15.4% carbon) is slightly higher than acid-insoluble lignin (16% carbon) in KBL-DM. NaBL-DM and KBL-DM had a low carbon from carbonate (1-1.8%).

There are two carbon types for the AC production which are classified as volatile carbon (called volatile matter) and non-volatile carbon (called fixed carbon). The process of the AC production consists of two major processes: carbonization (HTC and carbonization) and activation. Fixed carbon is mostly converted to char by a thermal process (HTC and/or carbonization) prior to the activation process, while most volatile carbon is off-gassed during the thermal process. Lignin, having molecular structures similar to bituminous coal, has a high fixed carbon, while carbohydrates have a high volatile matter content which is mostly not convertible to hydrochar or char. The carbon profiles in NaBL and KBL (or NaDM and KDM) suggest that the carbon of carbohydrates in NaBL and KBL (or NaDM and KDM) yields a low char conversion which results in a low overall AC yield.

TABLE 12
Carbon profiles in dry matter (on a dry basis).

| | NaBL-derived | KBL-derived |
|---|---|---|
| Carbon type in DM | DM | DM |
| Carbon content from recoverable | 16.0% | 15.4% |
| lignin content (acid insoluble | | |
| lignin-C) | | |
| Carbon content from carbohydrate | 13.7% | 16.0% |
| (Primary carbonate-C (primary ) | | |
| and acid-soluble lignin C) | | |
| Carbon content from carbonate | 1.8% | 1.0% |
| (Carbonate-C) | | |
| Total C in DM | 31.4% | 32.3% |

Table 13 summarizes major inorganic elements (on a dry basis) in dry matter (water removed at 105° C.) derived from the BL samples. NaBL-DM had similar inorganic element content to KBL-DM. NaBL-DM had 12.0% Na (20.9% NaOH stoichiometrically calculated), 2.39% K (3.43% KOH stoichiometrically calculated) and 0.7% Si (1.51% SiO₂, stoichiometrically calculated). KBL-DM was tested to have 15.9% K (22.82% KOH stoichiometrically calculated), 0.4% Na (3.43% NaOH stoichiometrically calculated), and 0.68% Si (0.68% SiO₂, stoichiometrically calculated).

TABLE 13
Major inorganic elements in DM.

| Elements | NaBL-DM | KBL-DM |
|---|---|---|
| Sodium | 12.0% (20.9% NaOH) | 0.40% (0.69% NaOH) |
| Potassium | 2.4% (3.43% KOH) | 15.9% (22.82% KOH) |
| Silicon | 0.70% (1.51% SiO2) | 0.68% (1.45% SiO2) |
| Sulfur | 0.12% | 0.06% |

Note:
Silicon and sulfur were semi-quantified.

Table 14 shows HTC conditions for hydrochar production from wheat straw black liquor. NaBL and KBL samples were tested for hydrochar production at a temperature ranging from 180 to 310° C. for 5 to 10 hrs. CO₂-pressurization was used for the HTC trials without any catalyst. The as-received black liquor samples were viscous. The HTC trials used the BL samples with and without water dilution.

TABLE 14
HTC conditions for HC production from wheat straw black liquor.

| | HTC conditions with CO₂ pressurization and no | | |
|---|---|---|---|
| | catalyst | | |
| | Dilution of | Soak temperature | Soak time |
| Type of BL | BL:Water | (° C.) | (hr) |
| NaBL | 1 BL:1 Water | 180 | 5 |
| | 1 BL:1 Water | 280 | 5 |
| | 1 BL:1 Water | 280 | 10 |
| | No dilution | 280 | 10 |
| | 1 BL:1 Water | 310 | 5 |
| KBL | 1 BL:1 Water | 180 | 5 |
| | 1 BL:1 Water | 280 | 5 |
| | No dilution | 280 | 10 |

Table 15 summarizes the yields and analytical results of hydrochar from Na and K based BL samples, respectively. The goal of the HTC process is to produce high carbon-containing hydrochar with a high yield. As shown in Table 15, the best results (Batch #8 from NaBL and Batch #9 from KBL) were determined based on carbon content in hydrochar and carbon yields which were calculated based on total carbon content in the BL samples.

Na-based BL samples were hydrothermally carbonized to hydrochar (Denoted as NaBL-HC) with carbon yields of 23 to 31.7% (62.7-68.5% carbon content in hydrochar) at 180-310° C. HTC for 5-10 hrs. The carbon yield of KBL-HC (derived from KBL) was 22.7-39% (63.5-66.8% carbon content in KBL-HC) at the same HTC conditions. These overall carbon yields were low when compared to the wood pulp (tree)-derived black liquor sample characterized above (approximately 78% carbon yield). It appears that the wheat straw BL samples contain high carbon from carbohydrates which are non-recoverable through HTC.

TABLE 15
Product yield and analytical results of hydrochar.

| | | | | Ash | Total |
|---|---|---|---|---|---|
| | | | Carbon | content | carbon |
| Parameters and ID | | | content (%) | (%) | yield (%) |
| Na- | HTC soak temp at | Batch | 52.4% (looks | 18.50% | 23.0% |
| based | 180° C. for 5 hrs | #1 | like lignin) | | |
| BL | HTC soak temp at | Batch | 62.70% | 17.09% | 23.6% |
| | 280° C. for 5 hrs | #2 | | | |
| | | Batch | 63.40% | 16.42% | 23.6% |
| | | #3 | | | |
| | HTC soak temp at | Batch | 65.30% | 16.54% | 24.5% |
| | 280° C. for 10 hrs | #4 | | | |
| | HTC soak temp at | Batch | 68.50% | 11.51% | 31.7% |
| | 280° C. for 10 hrs | #8 | | | |
| | (no dilution) | | | | |
| | HTC soak temp at | Batch | 66.50% | 16.81% | 22.7% |
| | 310° C. for 5 hrs | #5 | | | |
| K- | HTC soak temp at | Batch | 63.50% | 17.18% | 27.0% |
| based | 280° C. for 5 hrs | #6 | | | |
| BL | | Batch | 63.20% | 16.70% | 27.5% |
| | | #7 | | | |
| | HTC soak temp at | Batch | 66.80% | 15.52% | 39.0% |
| | 280° C. for 10 hrs | #9 | | | |
| | (no dilution) | | | | |

NOTE:
Total carbon yields were calculated based on total C in BL.

Table 16 shows the proximate analysis of hydrochar and char derived from NaBL. Since NaBL has a similar chemical content in terms of lignin content, total carbon content, and alkali content, NaBL-HC (hydrochar derived from NaBL) and NaBL-HCC (HC additionally carbonized at 550° C. for 1 hr) is representative of the wheat straw BL samples. Proximate analysis, including volatile matter (VM), fixed carbon (FC), and ash content, was originally developed by coal industries to determine coal fuel quality and coke production (high fixed carbon indicating high energy content and high Coke yields). For char production, high fixed content indicates high char yield.

A mass ratio of FC/VM is 0.8 for HC, while HCC has a mass ratio of 5. The removal of volatiles prior to the KOH activation is critical for high-quality AC production. The activation process uses KOH as an oxidizing agent to develop carbon surfaces in this work. Fixed carbon of hydrochar or char has less available for the activated surface developments when the volatile matter of hydrochar or char reacts with free oxygen from the KOH oxidizing agent.

HC samples (Batches #3 and #7 in Table 15) were selected for further carbonization and then activation to produce AHCC, while HC samples (Batches #2 and #6 in Table 15) were directly activated for AHC production for the comparison.

TABLE 16
Proximate analysis of hydrochar (HC) and HC-char (HCC).

| | Volatile matter | Fixed carbon | Ash content | Mass ratio |
|---|---|---|---|---|
| Char type | (%) | (%) | (%) | of FC/VM |
| NaBL-HC | 49.5% | 39.0% | 17.1% | 0.8 |
| NaBL-HCC | 13.9% | 69.1% | 28.8% | 5.0 |

Table 17 summarizes key performance indicators (KPIs) of wheat straw activated carbon which are compared to a benchmark activated carbon YPAC (YP50F, obtained carbon, Calgon). The benchmark YPAC is called supercapacitor carbon which is suitable for electrode materials of supercapacitors.

Batch #2 (NaBL-HC) was activated using KOH as an oxidizing agent. The activated Batch #2 was denoted as NaBL-AHC. Batch #3 was additionally carbonized (denoted as NaBL-HCC) and then activated (denoted as NaBL-AHCC). KBL-AHC and KBL-AHCC were produced in the same manner using KBL-HC, respectively.

Iodine values (measured by ASTM4607 and expressed mg of iodine adsorbed in 1 g of activated carbon) indicate the most fundamental parameter of adsorbent quality in aqueous phases estimating its surface area and micro-porosity (<2 nm pores). The electrodes (soaked in an aqueous electrolyte in a supercapacitor system) electrostatically adsorb negative and positive ions of the electrolyte when the supercapacitor is charged. The absorbed ions are pulled back in the bulk electrolyte when the supercapacitor is discharged. Therefore, electrodes having a high iodine value provide a high capacitance (Farad per g of activated carbon) which is a key performance indicator of the supercapacitor to hold an electrical charge.

Wheat straw ACs had high iodine values ranging 1,670 to 2,003 mg/g, while the benchmark YPAC had an iodine value of 1,849 mg/g. These results suggest that wheat straw activated carbon is highly adsorptive. AHCC had iodine values (1,720-2,003 mg/g) higher than AHC (1,670-1,872 mg/g) derived from NaBL and KBL, respectively. This indicates that removing volatile matter (VM) before activation improves the efficacy of the KOH activation.

Wheat straw activated carbon had high ash content (11.6 to 17.3%). Wheat straw AHC and AHCC contain unreacted potassium hydroxide after the activation. The as-produced ACs were placed in reverse osmosis water to recover unreacted KOH and then washed with a stoichiometric amount of 2M-HCl. The high ash suggests that the 2^{nd} acid-washing requires an excess amount of HCl to reduce ash content in activated HC or HCC.

TABLE 17
KPIs of wheat straw activated carbon in
comparison of benchmark activated carbon.

| | | | | Iodine | Carbon | Ash |
|---|---|---|---|---|---|---|
| Feedstock | Batch | | Carbon | values | content | content |
| ID | ID | Description | ID | (mg/g) | (%) | (%) |
| NaBL | Batch | activated from | NaBL- | 1,872 | 75.4% | 6.84% |
| | #2 | hydrochar (NaBL-HC) | AHC | | | |
| | Batch | NaBL-HC carbonized | NaBL- | 2,003 | 75.3% | 11.62% |
| | #3 | at 550° C. for 1 hr and | AHCC | | | |
| | | then activated | | | | |
| KBL | Batch | KBL-HC activated | KBL-AHC | 1,670 | 77.5% | 12.12% |
| | #6 | from hydrochar | | | | |
| | Batch | KBL-HC carbonized at | KBL- | 1,720 | 71.4% | 17.25% |
| | #7 | 550° C. for 1 hr and then | AHCC | | | |
| | | activated | | | | |

| | | | | | |
|---|---|---|---|---|---|
| YPAC (YP50F | Commercial AC | YPAC | 1,865 | 99.24% | 0.35% |
| activated carbon, | | | | | |
| Calgon) | | | | | |

Table 18 shows KPIs of wheat straw ACs were improved by removing volatile matter before the activation and using an excess amount of HCl for de-ashing after activation.

Batch #8 was additionally carbonized and then activated. The resultant AHCC was washed with an excess amount of HCl. Batch #9 was activated using the hydrochar. The resultant AHC was washed with the excess amount of HCl. NaBL-AHCC (Batch #8) achieved a high iodine number of 3,082 mg/g, a high carbon content of 94.4%, and a low ash content of 1.22%. KBL-AHC (Batch #9) was also tested to be a high iodine value of 2,461 mg/g, a high carbon content of 91.5%, and a low ash content of 0.88%.

Since NaBL-AHCC from Batch #8 achieved the best values of KPIs among all batch trials. The NaBL-AHCC was selected to further treatments with the sweeping gas.

TABLE 18
KPIs of wheat straw activated carbon improved by VM removal
before activation and washing with an excess amount of HCl.

| Feedstock | | | | Carbon | |
|---|---|---|---|---|---|
| and | Btach | Carbon | Iodine values | content | Ash content |
| comparison | ID | Type | (mg/g) | (%) | (%) |
| NaBL | Batch | AHCC | 3,082 | 94.4% | 1.22% |
| | #8 | | | | |
| KBL | Batch | AHC | 2,461 | 91.5% | 0.88% |
| | #9 | | | | |

NOTE:
All content (%) are on a dry basis.

The wheat straw AHCC was subject to the SG treatment, which flushed the carbon with a gas mixture containing 90% nitrogen and 10% hydrogen at 800° C. for 3 hrs. This final post-treatment method after the activation removes the oxygen groups chemically bound to the activated carbon. By reacting/stripping the bound oxygen with the sweeping gases at high temperatures, the SG-treated carbon products were altered to yield lower electrical resistance, higher carbon content, and improved surface area properties.

Table 19 shows KPI values of wheat straw lignin-based AC which was treated with the sweeping gas (AHCC+SG) and then compared to YPAC+SG. Iodine and surface area values of wheat straw AC were much higher (3,209 mg/g and 3,056 m²/g) than YPAC+SG (2,048 mg/g and 1,876 m²/g). The surface area was estimated using the correction (y=0.9374x+47.781 R²=0.9416) between the iodine values and surface area based on previous results.

AHCC+SG had a carbon content of 97.4% and an ash content 1.63% which are lower and higher than YPAC+SG (99% carbon and 0.38% ash content), respectively. The relative resistance of wheat straw AC (131%) was significantly lower than YPAC (434%). It is clearly shown that the wheat straw AC had superior adsorptive ion capability and electrical properties.

The tested resistance (%), indicating an electrical resistance, was correlated to a relative alternating current resistance (% ACR) based on the resistance of graphite (obtained from MTI Corp., USA). The relative resistance of wheat straw AC (131%) was significantly lower than YPAC (434%). It is clearly shown that the wheat straw AC had superior adsorptive ion capability and electrical properties.

TABLE 19
KPIs of wheat straw activated carbon after SG treatment.

| | | Iodine | | Carbon | Ash | Relative |
|---|---|---|---|---|---|---|
| | | values | Surface | content | content | resistance |
| Carbon ID | Batch ID | (mg/g) | area (m²/g) | (%) | (%) | (%) |
| Wheat Straw | Batch #8 | 3,209 | 3,056 | 97.4 | 1.63% | 131% |
| AHCC + SG | | | (Estimated) | | | |
| YPAC + SG | Not applicable | 2,048 | 1,876 | 99.00% | 0.38% | 434% |
| | | | (measured) | | | |

Table 20 summarizes the initial capacitance (capability of storing electric charge) and internal resistance of supercapacitors with AHCC+SG. A carbon slurry was prepared using 75% AHCC+SG, 10% graphite-based conductive agent, and 15% PVDF binder. The coated carbon composite was assembled in CR2032 (15 mm in diameter) cells. The AHCC+SG based supercapacitors had a capacitance ranging 155.3 to 168.2 F/g tested at a low discharge rate (0.5 g/A) and 144.7-156.1 F/g tested at a fast discharge rate (5.0 Arg) while YPAC+SG (YPAC treated with SG) had significantly lower capacitance (76.4-81.1 F/g) than AHCC+SG. The internal resistance of the AHCC+SG supercapacitors ranged from 17.6 to 22 mΩ-g while YPAC+SG had 88 to 149 mΩ-g. The best 3 in each group were selected for 600 cycling tests.

TABLE 20
Initial capacitance of supercapacitors with wheat straw activated carbon.

| | | | | Internal | Initial | |
|---|---|---|---|---|---|---|
| | Slurry formulation | Cell | Discharge | resistance | capacitance | |
| Carbon ID | (AC:graphite:binder) | ID | rate (A/g) | (mΩ-g) | (F/g) | Note |
| Wheat | 75:10:15 | #52-1 | 0.5 | 18.4 | 166.7 | |
| straw | | | 5.0 | | 156.1 | |
| AHCC + SG | | #52-2 | 0.5 | 22.0 | 168.2 | Worst |
| | | | 5.0 | | 154.1 | |
| | | #52-3 | 0.5 | 17.6 | 159.0 | |
| | | | 5.0 | | 149.7 | |
| | | #52-4 | 0.5 | 18.3 | 155.3 | |
| | | | 5.0 | | 144.7 | |
| YPAC + SG | 80:10:10 | #20-13 | 0.5 | 149 | 77.2 | Worst |
| for | | | 5.0 | | 18.3 | |
| comparison | | #20-14 | 0.5 | 138 | 76.4 | |
| | | | 5.0 | | 18.3 | |
| | | #20-15 | 0.5 | 94 | 75.7 | |
| | | | 5.0 | | 33.0 | |
| | | #20-16 | 0.5 | 88 | 81.1 | |
| | | | 5.0 | | 44.3 | |

Table 21 summarizes the capacitance and internal resistance after 600 cycles (300 cycles at a slow charge-discharge rate (0.5 A/g) and 300 cycles at a fast charge-discharge rate (5.0 A/g)). The AHCC+SG-based supercapacitors achieved high capacitance with a low internal resistance after 600 cycles. The superior performance of the AHCC+SG-based supercapacitors suggests that the AHCC+SG is very suitable for electrode materials in energy storage applications.

The AHCC+SG supercapacitors had 153.6-166.3 F/g at 0.5 A/g and 138.8-149.4 F/g at 5.0 A/g, while 74.2-78.9 at 0.5 A/g and 6.1 to 31.3 at 5.0 A/g. Particularly the capacitance of YPAC+SG-based supercapacitors significantly decreased the capacitance at 5.0 A/g after 600 cycles. The AHCC+SG had internal resistances ranging 19.85-22.05 ms-g which are almost the same as the initial internal resistance (17.6 to 22 mΩ-g). YPAC had significantly increased the internal resistance (150-164 mΩ-g) which suggests why the capacitance decreased after 600 cycles.

TABLE 21
The 600-cycle capacitance of supercapacitors with wheat straw activated carbon.

| | | | | Internal | |
|---|---|---|---|---|---|
| | Slurry formulation | Cell | Discharge | resistance | Capacitance |
| Carbon ID | (AC:graphite:binder) | ID | rate (A/g) | (mΩ-g) | (F/g) |
| Wheat | 75:10:15 | #52-1 | 0.5 | 22.05 | 166.3 |
| straw | | | 5.0 | | 149.4 |
| AHCC + SG | | #52-2 | 0.5 | 22.2 | 159.4 |
| | | | 5.0 | | 148.1 |
| | | #52-3 | 0.5 | 19.85 | 153.6 |
| | | | 5.0 | | 138.8 |
| YPAC + SG | 80:10:10 | #20-14 | 0.5 | 194 | 74.2 |
| for | | | 5.0 | | 6.1 |
| comparison | | #20-15 | 0.5 | 186 | 75.0 |
| | | | 5.0 | | 9.6 |
| | | #20-16 | 0.5 | 150 | 78.9 |
| | | | 5.0 | | 31.3 |

Based on the foregoing experimental results, it can be concluded that the sweeping gas treatment is particularly effective in enhancing the properties of lignin-based activated carbon as compared with coconut shell-based activated carbon as a reference biocarbon feedstock. The inventors obtained favourable results in experiments examining the effectiveness of enhancing the properties of activated carbon produced from both wood pulp and wheat straw-derived black liquor using the sweeping gas treatment. The lignin-based activated carbons show significantly improved adsorptive capability and electrical properties after the sweeping gas treatment resulting in high capacitance values in the supercapacitor applications. Typical activated carbons have high adsorptive capabilities, but not suitable electrical properties. The sweeping gas treatment can improve the adsorptive capability and the electrical properties so that the activated carbons derived from lignin are suitable for electrode materials in supercapacitors and LiS battery applications.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

### REFERENCES

The following references are of interest with respect to the subject matter described herein. Each of the following references is incorporated by reference herein in its entirety.
Ahvazi Behzad, et al. (2016), Elucidation and Characterization of West Fraser Black Liquor Derived and AITF Sulfur-Free Lignins for Application's Development. InnoTech Alberta
Ház, Aleš et al (2019) Chemical Composition and Thermal Behavior of Kraft Lignins, Forests 2019, 10, 483; doi:10.3390/f10060483
Kupgan, Grit et al. (2017) NLDFT Pore Size Distribution in Amorphous Microporous Materials, Langmuir 2017, 33, 11138-11145
Marsh, Harry (2006) Activation Carbon. Elsevier Ltd., CA, USA
MyWaterEarth&Sky, The Reason Coconut Shell Is the Best Activated Carbon, https://mywaterearth.com/is-the-best-activated-carbon-woodcoal-or-coconut/[Accessed 8 Jan. 2021]
Water Technology, Coconut shell based activated carbon with no greenhouse gas emission, https://www.watertechonline.com/home/article/15538115/coconut-shell-based-activated-carbon-with-no-greenhouse-gas-emission#:˜:text=Coconut%20shell%2Dbased%20activated %20carbons,ideal %20ca rbon%20for%20water%20purification. [Accessed 8 Jan. 2021]
Cui, Xinwel, Adven SuperCap and Battery Technology-Innovation and Commercialization. AdvEn Ind Inc. Published online 2016
Ház, Aleš et al (2019) Chemical Composition and Thermal Behavior of Kraft Lignins, Forests 2019, 10, 483; doi:10.3390/f10060483
Rosas, Juana M., et al (2014), Preparation of different carbon materials by thermochemical conversion of lignin, doi: 10.3389/fmats.2014.00029
Weinstein, Lawrence and Dash, Ranjan, (2013) Supercapacitor carbons: Have exotic carbons failed?, Materials Today, Volume 16, Number 10, October 2013

Various embodiments have a plurality of aspects, including at least the following:
A. A building or modular building component as described herein or recited in any claim herein, wherein the modular building component or portion of the building in which the energy storage system is incorporated is thermally insulating.
B. A building or modular building component as described herein or recited in any claim herein, wherein the modular building component or portion of the building in which the energy storage system is incorporated is thermally conductive.
C. A building or modular building component as described herein or recited in any claim herein, wherein the modular building component or portion of the building in which the energy storage system is incorporated is weatherproof.
D. A modular building component as described herein or recited in any claim herein, wherein the modular building component comprises an interior or exterior cladding panel, a flooring panel, a roofing panel, a countertop, a staircase, or cabinetry.
E. A building as described herein or recited in any claim herein, wherein the energy storage system is incorporated into walls, floors, ceilings and/or internal components of the building.
F. A building or modular building component as described herein or recited in any claim herein, wherein the energy storage system is permanently incorporated into the modular building component or into the building.
G. A building or modular building component as described herein or recited in any claim herein, wherein the energy storage system is removably incorporated into the modular building component or into the building, optionally by being contained within a compartment that is accessible via an access door, access panel, or detachable covering structure.
H. A building or modular building component as described herein or recited in any claim herein, comprising connectors for coupling the energy storage system to an electrical system of the building or of a building containing the modular building component.
I. A building as described herein or recited in any claim herein or a building containing a modular building component as described herein or recited in any claim herein, wherein the building is a warehouse.
J. A method of treating black liquor by hydrothermal carbonization, the method comprising the steps of: placing the black liquor under a carbon dioxide atmosphere at an initial pressure in the range of 30-80 psig at room temperature; then subsequently increasing the temperature to an elevated temperature of between 200 and 320° C. at a pressure of between about 900 to about 1500 psig, optionally for a period of between 2-10 hours, wherein the resultant product is optionally activated subsequent to hydrothermal carbonization to produce activated carbon.
K. The method as described in aspect J, wherein the black liquor comprises black liquor obtained from a wood pulping process and/or a cereal grain pulping process, wherein the cereal grain is optionally wheat straw.

1. A method of producing activated carbon, comprising:
providing lignin or a high-lignin feedstock;
producing activated carbon from the lignin or high-lignin feedstock; and
exposing the activated carbon to a sweeping gas at a first elevated temperature.

2. A method of producing activated carbon, comprising exposing the activated carbon to a sweeping gas at a first elevated temperature, wherein the activated carbon comprises activated carbon produced from lignin or a high-lignin feedstock.

3. The method as defined in claim 2, wherein the lignin comprises lignin A, lignin B, lignin C, or a mixture thereof.

4. The method as defined in claim 2, wherein the high-lignin feedstock comprises black liquor, optionally from a kraft pulping process.

5. The method as defined in claim 2, wherein the high-lignin feedstock comprises black liquor produced from pulping hardwood, softwood, or a combination of hardwood and softwood, or wherein the high-lignin feedstock comprises black liquor produced from pulping a cereal grain, optionally wherein the cereal grain is wheat straw.

6. The method as defined in claim 2, wherein the high-lignin feedstock comprises at least 65% lignin dry matter content by weight, or wherein the high-lignin feedstock comprises at least 20%-35% recoverable lignin content by weight on a dry basis.

7. The method as defined in claim 2, wherein the sweeping gas comprises a combination of an inert gas and a reducing gas, wherein optionally the inert gas comprises nitrogen, argon or helium; and wherein optionally the reducing gas comprises hydrogen, ammonia, carbon monoxide, forming gas or syngas, and wherein optionally the sweeping gas comprises between about 80% and about 99% of the inert gas and about 1% to about 20% of the reducing gas.

8. (canceled)

9. (canceled)

10. The method as defined in claim 2, wherein the first elevated temperature is between about 750° C. and about 950° C.

11. The method as defined in claim 2, wherein:
during the step of exposing the activated carbon to the sweeping gas, the sweeping gas is supplied at a superficial velocity of between 3.5 and 7.5 cm/minute;
during the step of exposing the activated carbon to the sweeping gas, the sweeping gas is sprayed over or through the activated carbon;
the step of exposing the activated carbon to the sweeping gas is conducted at atmospheric pressure; or
the step of exposing the activated carbon to the sweeping gas is conducted for a period of between 0.5 hours and 9 hours.

12. (canceled)

13. (canceled)

14. (canceled)

15. The method as defined in claim 1, wherein the step of producing activated carbon comprises chemical activation or thermal activation, optionally wherein the step of producing activated carbon comprises adding an oxidant to the lignin or high-lignin feedstock at a second elevated temperature, wherein the oxidant optionally comprises an alkali metal hydroxide and wherein the second elevated temperature optionally comprises a temperature of between 500-900° C., wherein optionally the activation step is conducted for a period of between about 0.5 and 5 hours.

16. (canceled)

17. The method as defined in claim 1, comprising, prior to the step of producing the activated carbon, subjecting the lignin or high-lignin feedstock to a carbonization process, wherein the carbonization process optionally comprises heating the lignin or high-lignin feedstock in an oxygen-free atmosphere at a temperature in the range of about 500-900° C. for a period of about 5 hours.

18. The method as defined in claim 17, comprising, subsequent to the step of subjecting the lignin or high-lignin feedstock to a carbonization process, deashing the carbonized lignin or high-lignin feedstock, optionally wherein the lignin is lignin B.

19. The method as defined in claim 1, wherein the high-lignin feedstock comprises black liquor, and wherein, prior to the step of producing activated carbon, the black liquor is subjected to a pressurized hydrothermal carbonization step, wherein the pressurized hydrothermal carbonization step is optionally conducted by first placing the high-lignin feedstock under a carbon dioxide atmosphere at an initial pressure in the range of 30-80 psig at room temperature, then subsequently increasing the temperature to a third elevated temperature of between 200 and 320° C. at a pressure of between about 1000 to about 1500 psig, optionally for a period of between 2-10 hours.

20. The method as defined in claim 1, wherein the step of producing activated carbon comprises chemical activation, and wherein a washing step is conducted subsequent to the step of producing activated carbon, optionally wherein the chemical activation is carried out using a strong base and wherein the washing step comprises washing with a strong acid.

21. The method as defined in claim 1, comprising drying the activated carbon prior to the step of exposing the activated carbon to the sweeping gas or micronizing the activated carbon prior to the step of exposing the activated carbon to the sweeping gas.

22. (canceled)

23. (canceled)

24. An activated carbon made by the method as defined in claim 2, the activated carbon optionally having:
a surface area as determined using nitrogen gas adsorption of at least 2500 m²/g;
a pore volume measured using nitrogen gas adsorption of at least 0.7 cc/g;
an iodine value of at least 2500 mg/g.

25. (canceled)

26. (canceled)

27. (canceled)

28. (canceled)

29. (canceled)

30. An activated carbon as defined in claim 24, wherein the high-lignin feedstock comprises black liquor, optionally black liquor extracted from a kraft pulping process, optionally black liquor produced from pulping hardwood, softwood, or a combination of hardwood and softwood.

31. (canceled)

32. (canceled)

33. An activated carbon as defined in claim 24, wherein the high-lignin feedstock comprises black liquor produced from pulping a cereal grain, optionally wherein the cereal grain is wheat straw.

34. (canceled)

35. An electrode comprising an activated carbon as defined in claim 24.

36. (canceled)

37. A supercapacitor or battery comprising or a building or modular building component containing an energy storage system comprising a supercapacitor or battery comprising an electrode as defined in claim 35.

38. (canceled)

39. (canceled)
